(19) United States
(12) Patent Application Publication
(10) Pub. No.: US 2016/0112180 A1
(43) Pub. Date: Apr. 21, 2016

(54) WIRELESS DEVICE FOR FULL DUPLEX RADIOS

(71) Applicant: Institute For Information Industry, Taipei (TW)

(72) Inventors: Shu-Han LIAO, New Taipei City (TW); Yi-Hsueh TSAI, New Taipei City (TW)

(21) Appl. No.: 14/884,737

(22) Filed: Oct. 15, 2015

Related U.S. Application Data
(60) Provisional application No. 62/065,022, filed on Oct. 17, 2014.

(51) Int. Cl. H04L 5/14; H01Q 21/00

(52) U.S. Cl. CPC H04L 5/1461; H01Q 21/0006

(57) ABSTRACT

A wireless device for full duplex radios (FDR) is provided. The wireless device includes an FDR transceiver and an antenna module. The antenna module has a plurality of antennas. Specific distances are designed among the antennas so as to cancel the self-interference to the received signal of the FDR transceiver from the transmitted signal of the FDR transceiver.

### PRIORITY

This application claims the benefit of priority based on U.S. Provisional Application Ser. No. 62/065,022 filed on Oct. 17, 2014, which is hereby incorporated by reference in its entirety.

### FIELD

The present invention relates to a wireless device for full duplex radios (FDR). More particularly, the present invention cancels self-interference to the received signal from the transmitted signal through design of distances between antennas.

### BACKGROUND

With the advancement of the science and technologies, people's demand for communication or data transmission through use of wireless devices (e.g., smartphones, tablet computers, notebook computers or the like) increases correspondingly. In the conventional radio frameworks, the wireless devices have to transmit a signal and receive a signal at different times (i.e., time division multiplexing) or have to transmit a signal and receive a signal in different frequency bands (i.e., frequency division multiplexing). In order to increase the signal transmission speed and the utilization efficiency of frequency bands, the full duplex radios (FDR) framework has been proposed and has become a hot topic in the academia and in the industry.

According to the FDR framework, a wireless device transmits a signal and receives a signal at the same time and with the same frequency. The two-way transmissions at the same time and with the same frequency can shorten the signal transmission time and increase the utilization efficiency of the frequency bands. However, because the signal transmission and the signal reception are done at the same time and with the same frequency, the wireless device receives not only the signal transmitted by other wireless devices, but also the signal transmitted by the wireless device itself. This leads to the problem of self-interference which might make the received signal unusable.

Accordingly, an urgent need exists in the art and in the industry to solve the problem of self-interference in the FDR framework.

### SUMMARY

The disclosure includes a wireless device. Through arrangement of antennas, certain embodiments of the invention can cancel the self-interference to the received signal from the transmitted signal of the wireless device so that signal transmissions can be done in the FDR framework.

Disclosed is a wireless device, which comprises a full duplex radios (FDR) transceiver and an antenna module. The FDR transceiver comprises a first transmit feeding point and a first receive feeding point, and is configured to transmit a first transmitted signal from the first transmit feeding point and receive a first received signal from the first receive feeding point. The antenna module comprises a first inverter, a first antenna, a second antenna and a third antenna. The first antenna is coupled to the first transmit feeding point via the first inverter. The second antenna is coupled to the first transmit feeding point. The third antenna is coupled to the first receive feeding point. The first antenna and the third antenna have a distance d_{1,3} therebetween, the second antenna and the third antenna have a distance d_{2,3} therebetween, and a distance difference between d_{1,3} and d_{2,3} is substantially 0.

Further disclosed is a wireless device, which comprises an FDR transceiver and an antenna module. The FDR transceiver comprises a first transmit feeding point and a first receive feeding point, and is configured to transmit a first transmitted signal from the first transmit feeding point and receive a first received signal from the first receive feeding point. The antenna module comprises a first inverter, a first adder, a first antenna, a second antenna and a third antenna. The first antenna is coupled to the first transmit feeding point. The second antenna is coupled to the first receive feeding point via the first inverter and the first adder. The third antenna is coupled to the first receive feeding point via the first adder. The first antenna and the second antenna have a distance d_{1,2} therebetween, the first antenna and the third antenna have a distance d_{1,3} therebetween, and a distance difference between d_{1,2} and d_{1,3} is substantially 0.

Also disclosed is a wireless device, which comprises an FDR transceiver and an antenna module. The FDR transceiver comprises a first transmit feeding point and a first receive feeding point, and is configured to transmit a first transmitted signal from the first transmit feeding point and receive a first received signal from the first receive feeding point. The antenna module comprises a first antenna, a second antenna and a third antenna. The first antenna is coupled to the first transmit feeding point. The second antenna is coupled to the first transmit feeding point. The third antenna is coupled to the first receive feeding point. The first antenna and the third antenna have a distance d_{1,3} therebetween, the second antenna and the third antenna have a distance d_{2,3} therebetween, and a distance difference between d_{1,3} and d_{2,3} is substantially λ/2. λ is a wavelength corresponding to an operation frequency of the FDR transceiver.

Still further disclosed is a wireless device, which comprises an FDR transceiver and an antenna module. The FDR transceiver comprises a first transmit feeding point and a first receive feeding point, and is configured to transmit a first transmitted signal from the first transmit feeding point and receive a first received signal from the first receive feeding point. The antenna module comprises a first adder, a first antenna, a second antenna and a third antenna. The first antenna is coupled to the first transmit feeding point. The second antenna is coupled to the first receive feeding point via the first adder. The third antenna is coupled to the first receive feeding point via the first adder. The first antenna and the second antenna have a distance d_{1,2} therebetween, the first antenna and the third antenna have a distance d_{1,3} therebetween, and a distance difference between d_{1,2} and d_{1,3} is substantially λ/2. λ is a wavelength corresponding to an operation frequency of the FDR transceiver.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a wireless device 1 according to a first embodiment of the present invention;

FIG. 2 is a schematic view of the wireless device 1 according to a second embodiment of the present invention;

FIG. 3 is a schematic view of the wireless device 1 according to a third embodiment of the present invention;

FIG. 4 is a schematic view of the wireless device 1 according to a fourth embodiment of the present invention;

FIG. 5 is a schematic view of the wireless device 1 according to a fifth embodiment of the present invention;

FIG. 6 is a schematic view of the wireless device 1 according to a sixth embodiment of the present invention;

FIG. 7 is a schematic view of a wireless device 2 according to a seventh embodiment of the present invention;

FIG. 8 is a schematic view of the wireless device 2 according to an eighth embodiment of the present invention;

FIG. 9 is a schematic view of the wireless device 2 according to a ninth embodiment of the present invention;

FIG. 10 is a schematic view of the wireless device 2 according to a tenth embodiment of the present invention;

FIG. 11 is a schematic view of the wireless device 2 according to an eleventh embodiment of the present invention;

FIG. 12 is a schematic view of the wireless device 2 according to a twelfth embodiment of the present invention;

FIG. 13 is a schematic view of a wireless device 3 according to a thirteenth embodiment of the present invention;

FIG. 14 is a schematic view of the wireless device 3 according to a fourteenth embodiment of the present invention;

FIG. 15 is a schematic view of the wireless device 3 according to a fifteenth embodiment of the present invention;

FIG. 16 is a schematic view of the wireless device 3 according to a sixteenth embodiment of the present invention;

FIG. 17 is a schematic view of the wireless device 3 according to a seventeenth embodiment of the present invention;

FIG. 18 is a schematic view of a wireless device 4 according to an eighteenth embodiment of the present invention;

FIG. 19 is a schematic view of the wireless device 4 according to a nineteenth embodiment of the present invention;

FIG. 20 is a schematic view of the wireless device 4 according to a twentieth embodiment of the present invention;

FIG. 21 is a schematic view of the wireless device 4 according to a twenty-first embodiment of the present invention; and

FIG. 22 is a schematic view of the wireless device 4 according to a twenty-second embodiment of the present invention.

### DETAILED DESCRIPTION

In the following description, the present invention will be explained with reference to certain example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention.

It should be appreciated that, in the following example embodiments and the attached drawings, elements unrelated to the present invention are omitted from depiction; and dimensional relationships among individual elements in the attached drawings are illustrated only for ease of understanding, but not to limit the actual scale.

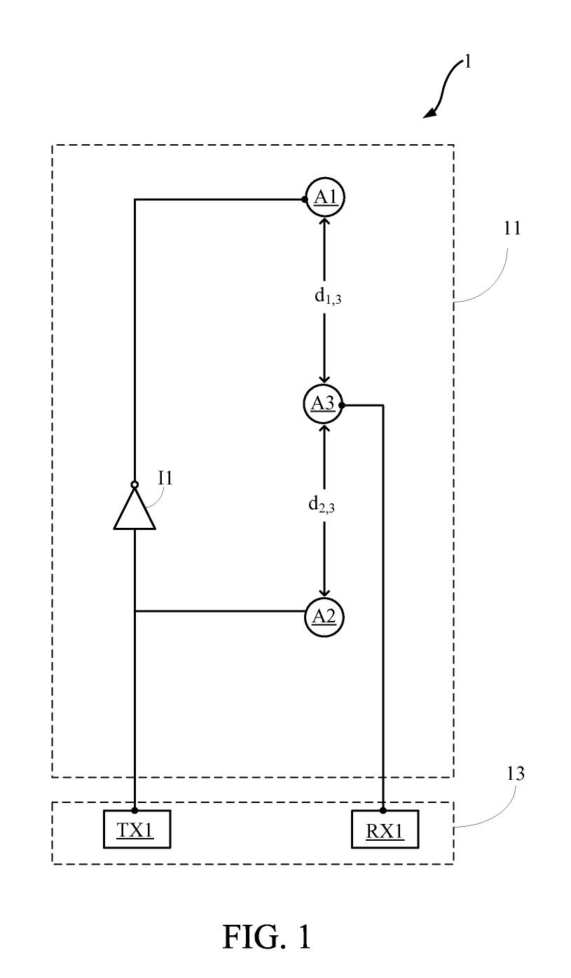

A first embodiment of the present invention is shown in FIG. 1, which is a schematic view of a wireless device 1 according to the present invention. The wireless device 1 comprises an antenna module 11 and a full duplex radios (FDR) transceiver 13. It shall be appreciated that, for purpose of simplicity, other components of the wireless device 1, e.g., a display module, a power source module, and an input module and components less related to the present invention are all omitted from depiction in the attached drawings.

The antenna module 11 comprises a first inverter I1, a first antenna A1, a second antenna A2 and a third antenna A3. The FDR transceiver 13 comprises a first transmit feeding point TX1 configured to transmit a first transmitted signal and a first receive feeding point RX1 configured to receive a first receive signal. Similarly, for purpose of simplicity, other components of the FDR transceiver 13, e.g., a radio frequency (RF) chip, an amplifier and a filter and components less related to the present invention are all omitted from depiction in the attached drawings.

The first antenna A1 is coupled to the first transmit feeding point TX1 via the first inverter I1, and the second antenna A2 is directly coupled to the first transmit feeding point TX1. Therefore, as being inverted by the first inverter I1, the first transmitted signal transmitted by the first antenna A1 is in opposite phase to the first transmitted signal transmitted by the second antenna A2. The third antenna A3 is coupled to the first receive feeding point RX1.

The first antenna A1 and the third antenna A3 have a distance d_{1,3} therebetween, and the second antenna and the third antenna have a distance d_{2,3} therebetween. In this embodiment, d_{1,3} and d_{2,3} are designed to be identical to each other (i.e., a distance difference between d_{1,3} and d_{2,3} is substantially 0) so that a component of the first transmitted signal transmitted by the first antenna A1 that is received at the third antenna A3 and that of the first transmitted signal transmitted by the second antenna A2 that is received at the third antenna A3 are offset by each other to eliminate the self-interference to the first received signal at the first receive feeding point RX1. It shall be appreciated that, because those of ordinary skill in the art can readily appreciate that transmitted signals in opposite phases can be transmitted to the receive antenna at the same time via different transmit antennas in the present invention so that interferences to the received signal from the transmitted signals are offset by each other, this will not be further described herein.

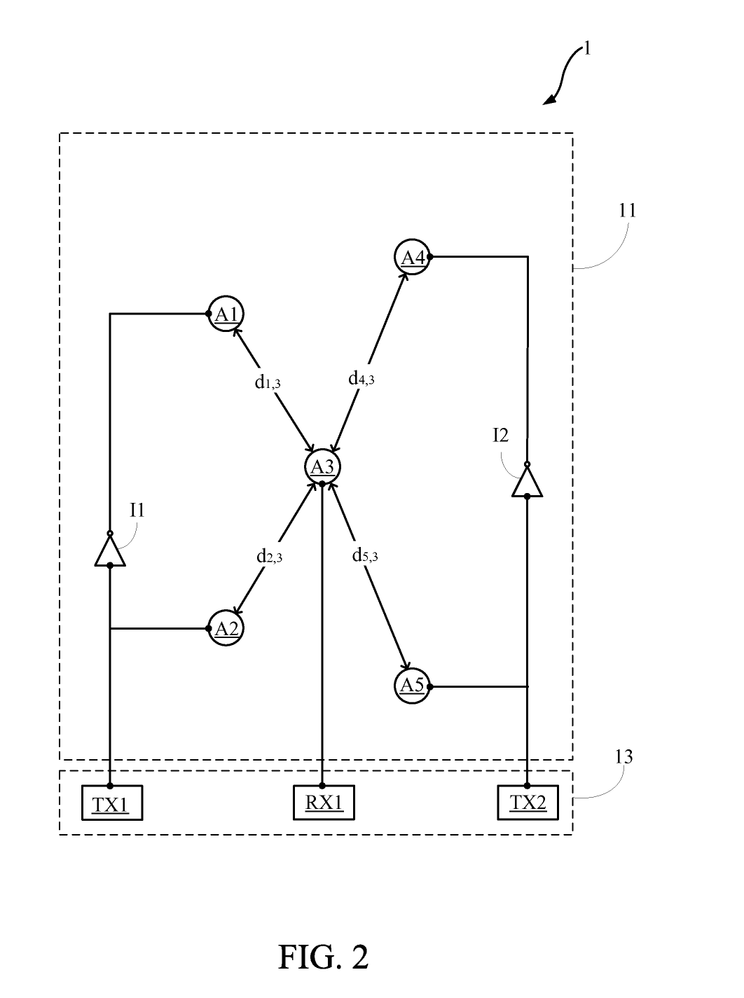

A second embodiment of the present invention is shown in FIG. 2, which is an extension of the first embodiment. In this embodiment, the FDR transceiver 13 further comprises a second transmit feeding point TX2 configured to transmit a second transmitted signal. The antenna module 11 further comprises a second inverter I2, a fourth antenna A4 and a fifth antenna A5. The antenna module A4 is coupled to the second transmit feeding point TX2 via the second inverter I2, and the fifth antenna A5 is directly coupled to the second transmit feeding point TX2. Accordingly, as being inverted by the second inverter I2, the second transmitted signal transmitted by the fourth antenna A4 is in opposite phase to the second transmitted signal transmitted by the fifth antenna A5.

The fourth antenna A4 and the third antenna A3 have a distance d_{4,3} therebetween, and the fifth antenna A5 and the third antenna A3 have a distance d_{5,3} therebetween. Similarly, in this embodiment, d_{4,3} and d_{5,3} are designed to be identical to each other (i.e., a distance difference between d_{4,3} and d_{5,3} is substantially 0) so that a component of the second transmitted signal transmitted by the fourth antenna A4 that is received at the third antenna A3 and that of the second transmitted signal transmitted by the fifth antenna A5 that is received at the third antenna A3 are offset by each other to eliminate the self-interference to the first received signal at the first receive feeding point RX1.

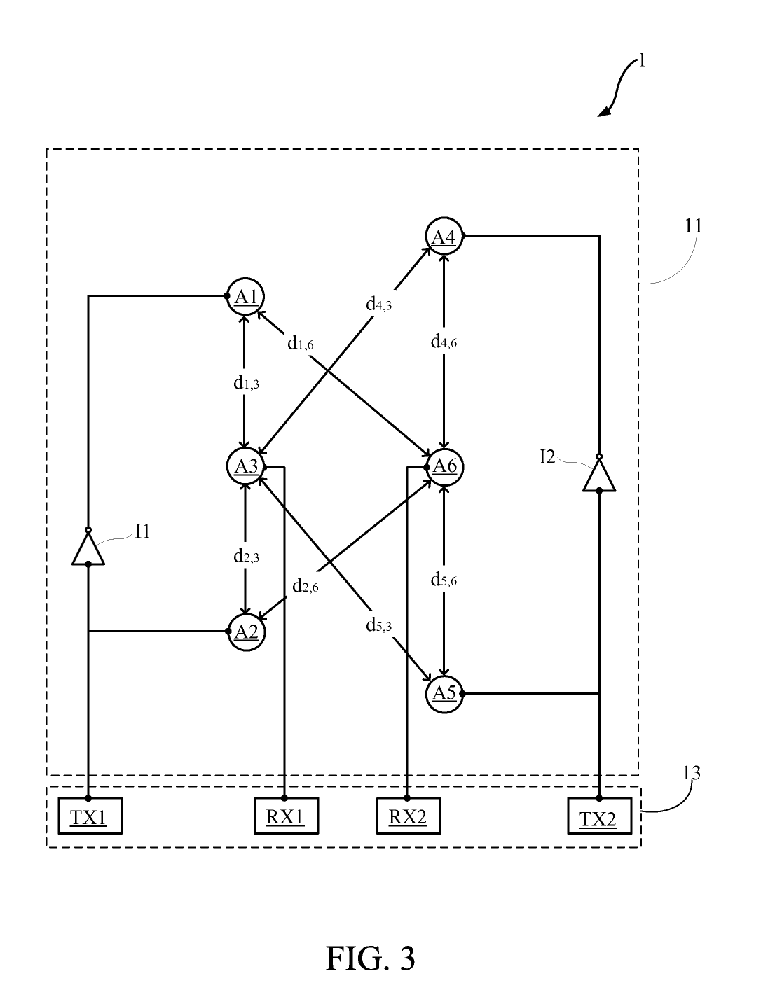

A third embodiment of the present invention is as shown in FIG. 3, which is an extension of the second embodiment. In this embodiment, the FDR transceiver 13 further comprises a second receive feeding point RX2 configured to receive a second receive signal. The antenna module 11 further comprises a sixth antenna A6 coupled to the second receive feeding point RX2.

The first antenna A1 and the sixth antenna A6 have a distance d_{1,6} therebetween, the second antenna A2 and the sixth antenna A6 have a distance d_{2,6} therebetween, the fourth antenna A4 and the sixth antenna A6 have a distance d_{4,6} therebetween, and the fifth antenna A5 and the sixth antenna A6 have a distance d_{5,6} therebetween. Similarly, d_{1,6} and d_{2,6} are designed to be identical to each other (i.e., a distance difference between d_{1,6} and d_{2,6} is substantially 0) and d_{4,6} and d_{5,6} are designed to be identical to each other (i.e., a distance difference between d_{4,6} and d_{5,6} is substantially 0) so that a component of the first transmitted signal transmitted by the first antenna A1 that is received at the sixth antenna A6 and that of the first transmitted signal transmitted by the second antenna A2 that is received at the sixth antenna A6 are offset by each other and a component of the second transmitted signal transmitted by the fourth antenna A4 that is received at the sixth antenna A6 and that of the second transmitted signal transmitted by the fifth antenna A5 that is received at the sixth antenna A6 are offset by each other to eliminate the self-interference to the second received signal at the second receive feeding point RX2.

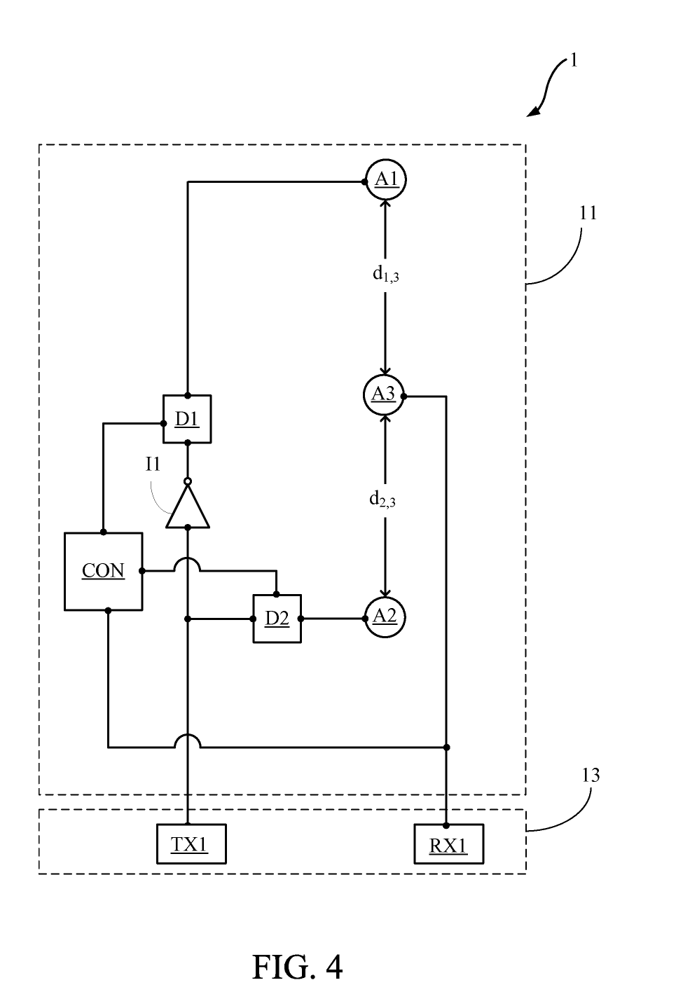

A fourth embodiment of the present invention is shown in FIG. 4, which is an extension of the first embodiment. In this embodiment, to solve the problem that the self-interference to the received signal cannot be cancelled due to positional errors of the antennas in practice, the antenna module 11 further comprises a controller CON, a first delayer D1 and a second delayer D2. The controller CON is coupled to the first delayer D1, the second delayer D2 and the first receive feeding point RX1, and is configured to adjust a delay value t1 of the first delayer D1 and a delay value t2 of the second delayer D2 according to the first received signal.

Specifically, the first antenna A1 is coupled to the first transmit feeding point TX1 via the first delayer D1 and the first inverter I1, and the second antenna A2 is coupled to the first transmit feeding point TX1 via the second delayer D2. When d_{1,3} and d_{2,3} are actually different from each other and have a distance difference Δd therebetween, a test signal can be transmitted in the present invention so that the controller CON calculates a correction value according to the received signal received at the first receive feeding point RX1 and, according to the correction value, adjusts the delay value t1 of the first delayer D1 and the delay value t2 of the second delayer D2 to compensate for the distance difference Δd between d_{1,3} and d_{2,3}.

Then, even if there is actually a distance difference Δd between d_{1,3} and d_{2,3}, the first transmitted signal transmitted by the first antenna A1 and the first transmitted signal transmitted by the second antenna A2 can also arrive at the third antenna A3 at the same time so that the components of the first transmitted signals received at the third antenna A3 can be offset by each other to eliminate the self-interference at the first receive feeding point RX1. It shall be appreciated that, the delayers are time delayers in this embodiment; however, the delayers may also be phase retarders or other components having a delaying effect in other embodiments. Furthermore, the controller CON is disposed in the antenna module 11 in this embodiment to adjust the delayers; however, the controller CON may also be disposed in the FDR transceiver 13 or be further integrated in an RF chip of the FDR transceiver 13 in other embodiments, and these variations all fall within the scope of the present invention.

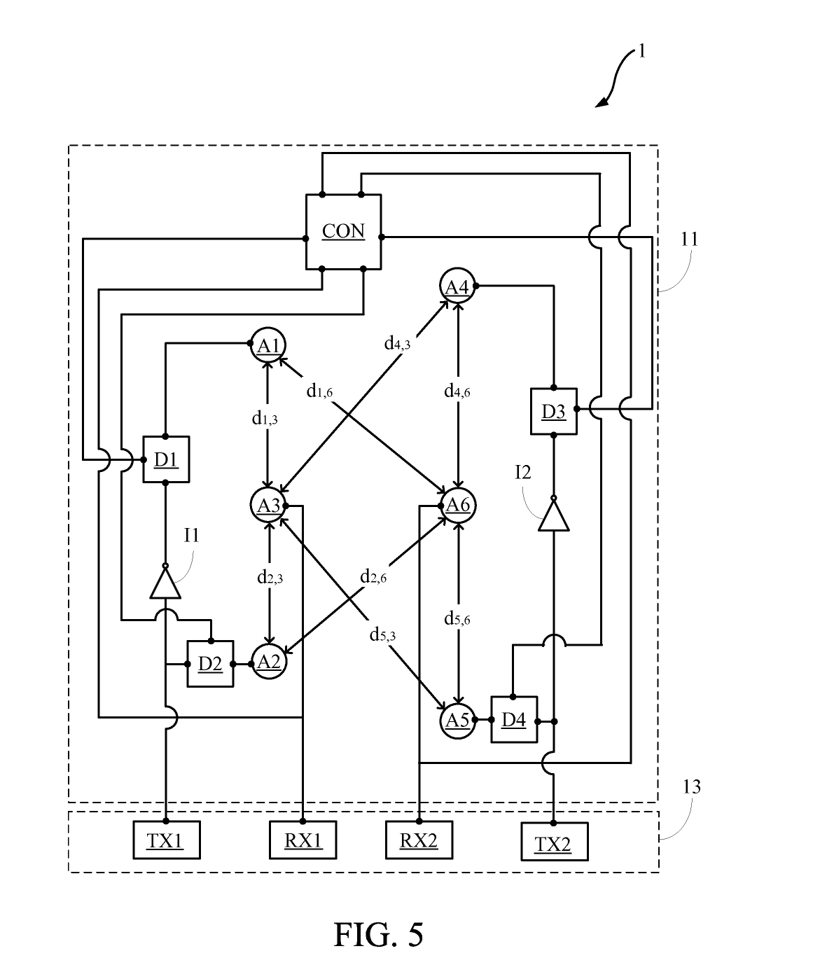

A fifth embodiment of the present invention is shown in FIG. 5, which is an extension of the third embodiment. Similarly, to solve the problem that the self-interference to the received signal cannot be cancelled due to positional errors of the antennas in practice, the antenna module 11 further comprises a controller CON, a first delayer D1, a second delayer D2, a third delayer D3 and a fourth delayer D4. The controller CON is coupled to the first delayer D1, the second delayer D2, the third delayer D3, the fourth delayer D4, the first receive feeding point RX1 and the second receive feeding point RX2.

The first antenna A1 is coupled to the first transmit feeding point TX1 via the first delayer D1 and the first inverter I1, the second antenna A2 is coupled to the first transmit feeding point TX1 via the second delayer D2, the fourth antenna A4 is coupled to the second transmit feeding point TX2 via the third delayer D3 and the second inverter I2, and the fifth antenna A5 is coupled to the second transmit feeding point TX2 via the fourth delayer D4. The controller CON adjusts a delay value t1 of the first delayer D1, a delay value t2 of the second delayer D2, a delay value t3 of the third delayer D3 and a the delay value t4 of the fourth delayer D4 according to the first received signal and the second received signal.

Specifically, in this embodiment, there is actually a distance difference Δd1 between d_{1,3} and d_{2,3}, a distance difference Δd2 between d_{4,3} and d_{5,3}, a distance difference Δd3 between d_{1,6} and d_{2,6}, and a distance difference Δd4 between d_{1,6} and d_{2,6}. In practice, it is impossible to compensate for the distance differences Δd1, Δd2, Δd3 and Δd4 at the same time so as to perfectly eliminate the self-interferences at the first receive feeding point RX1 and the second receive feeding point RX2. Therefore, in the present invention, the delay values t1, t2, t3 and t4 are decided according to an energy sum value of the first received signal received at the first receive feeding point RX1 and the second received signal received at the second received feeding point RX2 at a correction stage in such a way that the energy sum value of the first received signal and the second received signal is minimized to minimize the self-interferences.

In detail, the controller CON of the present invention can be designed to calculate optimal delay values t1, t2, t3 and t4 according to the genetic algorithm (GA), the Particle Swarm Optimization (PSO) algorithm, the Asynchronous Particle Swarm Optimization (APSO) algorithm, the Dynamic Differential Evolution (DDE) algorithm or some other similar algorithm to make Rp=Rs₁²+Rs₂² minimized, where Rp is the energy sum value, Rs₁ is the first received signal and Rs₂ is the second received signal. As how the delay values t1, t2, t3 and t4 are calculated according to an appropriate algorithm to minimize the self-interferences will be readily appreciated by those of ordinary skill in the art, this will not be further described herein.

It shall be further appreciated that, for purpose of simplicity, the aforesaid embodiments only describe aspects in which one set of transmit antennas is used in combination with one set of receive antennas, two sets of transmit antennas are used in combination with one set of receive antennas, and two sets of transmit antennas are used in combination with two sets of receive antennas; however, those of ordinary skill in the art can readily appreciate from the aforesaid embodiments that aspects in which any number of sets of transmit antennas are used in combination with any number of sets of receive antennas can be achieved in the present invention so long as every two antennas in each set of transmit antennas have substantially the same distance from an antenna in each set of receive antennas, and this will not be further described herein. Furthermore, the controller CON is disposed in the antenna module 11 in this embodiment to adjust the delayers; however, the controller CON may also be disposed in the FDR transceiver 13 or be further integrated in an RF chip of the FDR transceiver 13 in other embodiments, and these variations all fall within the scope of the present invention.

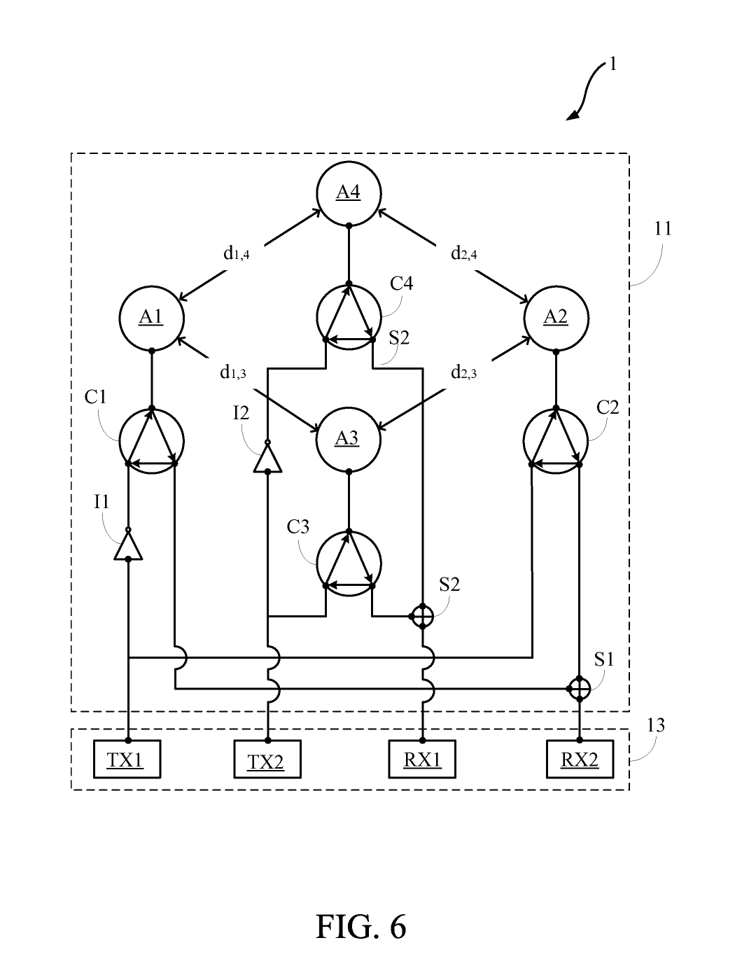

A sixth embodiment of the present invention is shown in FIG. 6, which is an extension of the first embodiment. In this embodiment, the FDR transceiver 13 further comprises a second transmit feeding point TX2 configured to transmit a second transmit signal and a second receive feeding point RX2 configured to receive a second receive signal. The antenna module 11 further comprises a fourth antenna A4, a second inverter I2, a first adder S1, a second adder S2, a first circulator C1, a second circulator C2, a third circulator C3 and a fourth circulator C4. Each of the circulators has a first port, a second port and a third port.

In this embodiment, each antenna serves to both transmit a signal and receive a signal at a same time. For each of the circulators, the first port is coupled to a transmit feeding point, and the second port is coupled to an antenna and the third port is coupled to a receive feeding point. Because the device property of the circulators is well known in the art, so it will not be further described herein. Additionally, to solve the problems of signal leakage between the first port and the third port of the circulators and the mutual interferences between transmitted signals of a same set of transmit antenna and receive antenna, the present invention further has signals at the third ports of the circulators of a same set of transmit and receive antennas added together via an adder before feeding the signals into the receive feeding point.

Specifically, for the first circulator C1, the first port is coupled to the first transmit feeding point TX1 via the first inverter I1, the second port is coupled to the first antenna A1, and the third port is coupled to the second receive feeding point RX2 via the first adder S1 so that the first antenna A1 is coupled to the first transmit feeding point TX1 and the second receive feeding point RX2 respectively via the first circulator C1. For the second circulator C2, the first port is coupled to the first transmit feeding point TX1, the second port is coupled to the second antenna A2, and the third port is coupled to the first receive feeding point RX2 via the first adder S1 so that the second antenna A2 is coupled to the first transmit feeding point TX1 and the second receive feeding point RX2 respectively via the second circulator C2.

For the third circulator C3, the first port is coupled to the second transmit feeding point TX2, the second port is coupled to the third antenna A3, and the third port is coupled to the first receive feeding point RX1 via the second adder S2 so that the third antenna A3 is coupled to the second transmit feeding point TX2 and the first receive feeding point RX1 via the third circulator C3. For the fourth circulator C4, the first port is coupled to the second transmit feeding point TX2 via the second inverter I2, the second port is coupled to the fourth antenna A4, and the third port is coupled to the first receive feeding point RX1 via the second adder S2 so that the fourth antenna A4 is coupled to the second transmit feeding point TX2 and the first receive feeding point RX1 respectively via the fourth circulator C4.

The first antenna A1 and the fourth antenna A4 have a distance d_{1,4} therebetween, and the second antenna A2 and the fourth antenna A4 have a distance d_{2,4} therebetween. Similarly, to eliminate the self-interference to the first received signal received at the first receive feeding point RX1 and the second received signal received at the second receive feeding point RX2, the antennas in this embodiment are disposed in such a way that a distance difference between d_{1,3} and d_{2,3} is substantially 0, a distance difference between d_{1,4} and d_{2,4} is substantially 0, a distance difference between d_{1,3} and d_{1,4} is substantially 0, and a distance difference between d_{2,3} and d_{2,4} is substantially 0. It shall be appreciated that, as in the fifth embodiment, delayers may be additionally disposed in this embodiment to compensate for the positional errors of the antennas through correction so as to minimize the self-interference; and because how the delayers are disposed for correction will be readily appreciated from the sixth embodiment by those of ordinary skill in the art, this will not be further described herein.

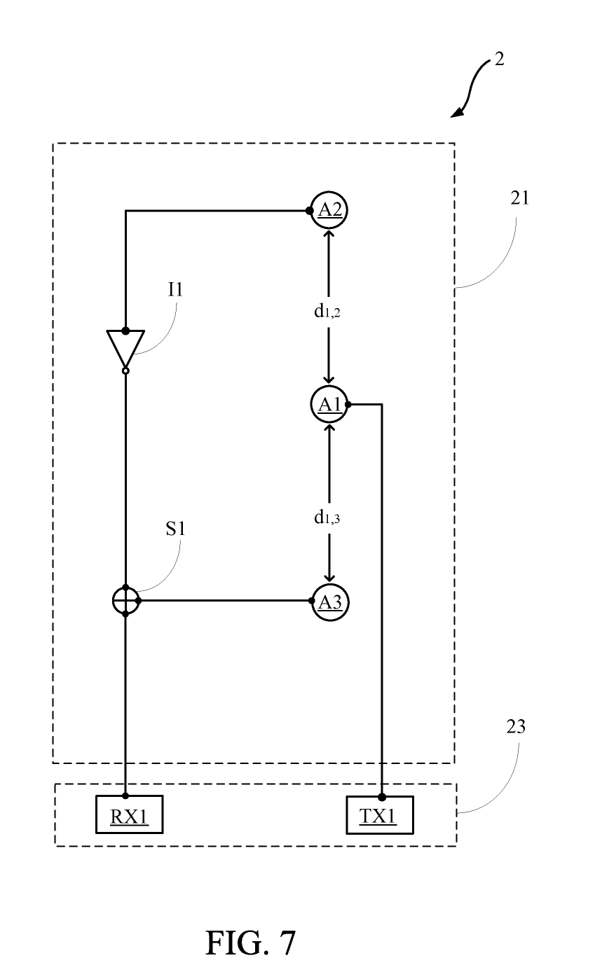

A seventh embodiment of the present invention is shown in FIG. 7, which is a schematic view of a wireless device 2 of the present invention. The wireless device 2 comprises an antenna module 21 and an FDR transceiver 23. The FDR transceiver 23 comprises a first transmit feeding point TX1 configured to transmit a first transmitted signal and a first receive feeding point RX1 configured to receive a first received signal. The antenna module 11 comprises a first inverter I1, a first adder S1, a first antenna A1, a second antenna A2 and a third antenna A3. The first antenna A1 is coupled to the first transmit feeding point TX1. The second antenna A2 is coupled to the first receive feeding point RX1 via the first inverter I1 and the first adder S1. The third antenna A3 is coupled to the first receive feeding point RX1 via the first adder S1.

The first antenna A1 and the second antenna A2 have a distance d_{1,2} therebetween, and the first antenna A1 and the third antenna A3 have a distance d_{1,3} therebetween. To eliminate the self-interference to the first received signal received at the first receive feeding point RX1, d_{1,2} and d_{1,3} are designed to be substantially identical to each other (i.e., a distance difference between d_{1,2} and d_{1,3} is substantially 0) in this embodiment. Specifically, because d_{1,2} and d_{1,3} are substantially identical to each other, the first transmitted signal transmitted by the first antenna A1 can be received simultaneously by the second antenna A2 and the third antenna A3. Because of this, the first transmitted signal component in the first received signal can be removed by inverting the signal received by the second antenna A2 and adding the inverted signal to the signal received by the third antenna A3.

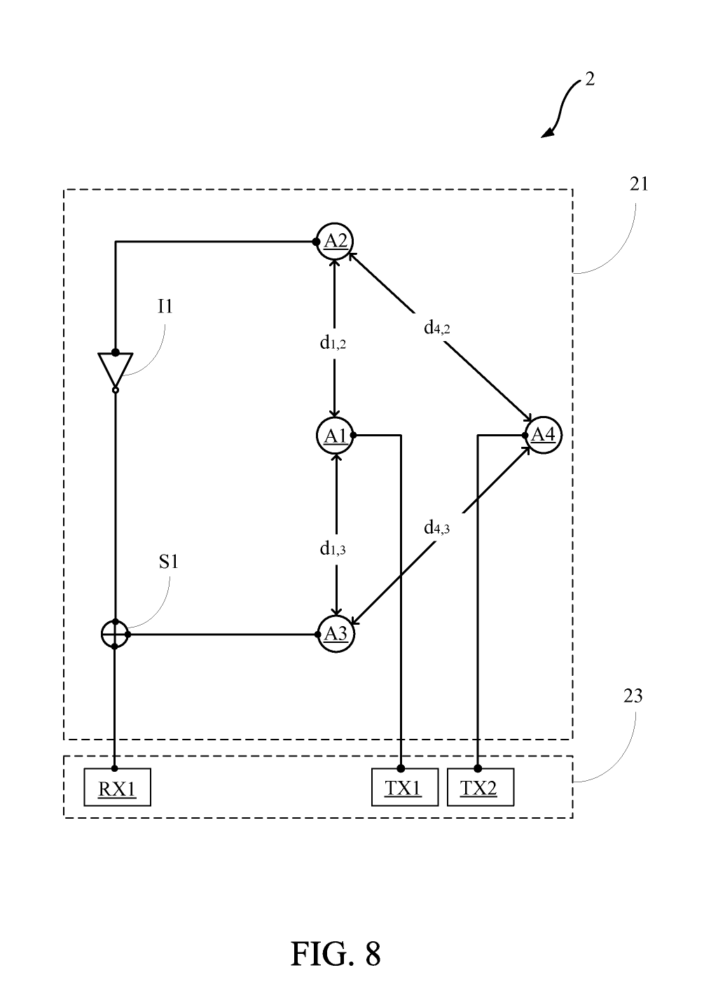

An eighth embodiment of the present invention is shown in FIG. 8, which is an extension of the seventh embodiment. In this embodiment, the FDR transceiver 23 further comprises a second transmit feeding point TX2 configured to transmit a second transmit signal. The antenna module 21 further comprises a fourth antenna A4. The fourth antenna A4 is coupled to the second transmit feeding point TX2. The fourth antenna A4 and the second antenna A2 have a distance d_{4,2} therebetween, and the fourth antenna A4 and the third antenna A3 have a distance d_{4,3} therebetween. Similarly, to eliminate the self-interference to the first received signal received at the first receive feeding point RX1, d_{4,2} and d_{4,3} are designed to be substantially identical to each other (i.e., a distance difference between d_{4,2} and d_{4,3} is substantially 0) in this embodiment.

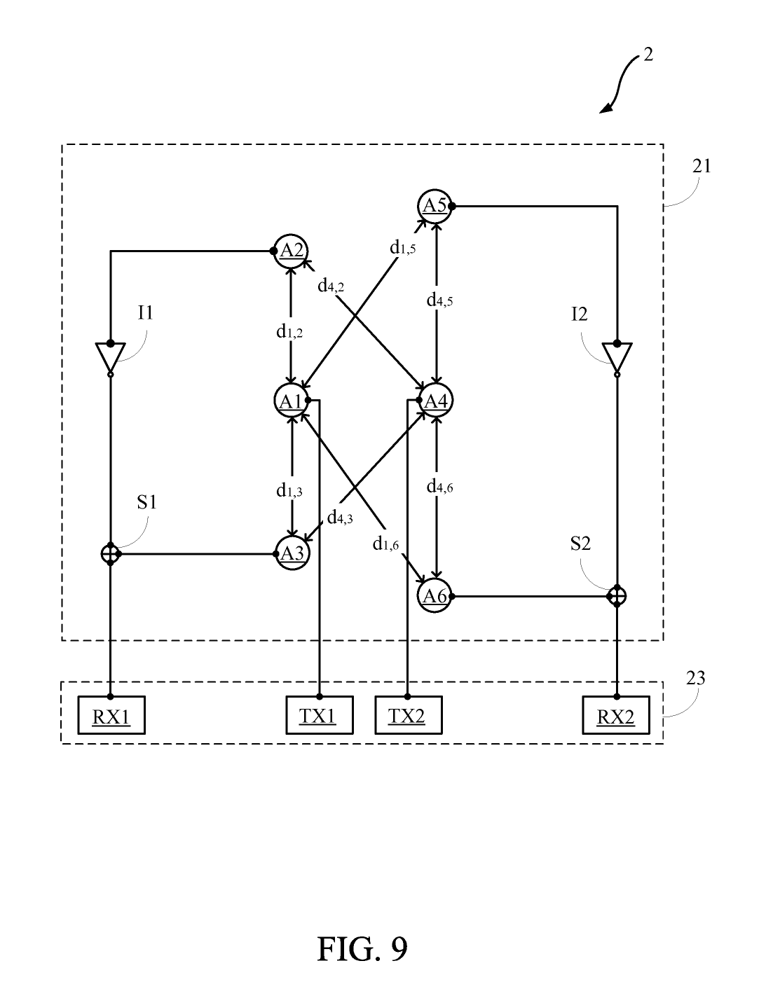

A ninth embodiment of the present invention is shown in FIG. 9, which is an extension of the eighth embodiment. The FDR transceiver 23 further comprises a second receive feeding point RX2 configured to receive a second receive signal. The antenna module 21 further comprises a second inverter I2, a second adder S2, a fifth antenna A5 and a sixth antenna A6. The fifth antenna A5 is coupled to the second receive feeding point RX2 via the second inverter I2 and the second adder S2. The sixth antenna A6 is coupled to the second receive feeding point RX2 via the second adder S2. The first antenna A1 and the fifth antenna A5 have a distance d_{1,5} therebetween, the first antenna A1 and the sixth antenna A6 have a distance d_{1,6} therebetween, the fourth antenna A4 and the fifth antenna A5 have a distance d_{4,5} therebetween, and the fourth antenna A4 and the sixth antenna A6 have a distance d_{4,6} therebetween. Similarly, to eliminate the self-interference to the second received signal received at the second receive feeding point RX2, d_{1,5} and d_{1,6} are designed to be substantially identical to each other (i.e., a distance difference between d_{1,5} and d_{1,6} is substantially 0) and d_{4,5} and d_{4,6} are designed to be substantially identical to each other (i.e., a distance difference between d_{4,5} and d_{4,6} is substantially 0) in this embodiment.

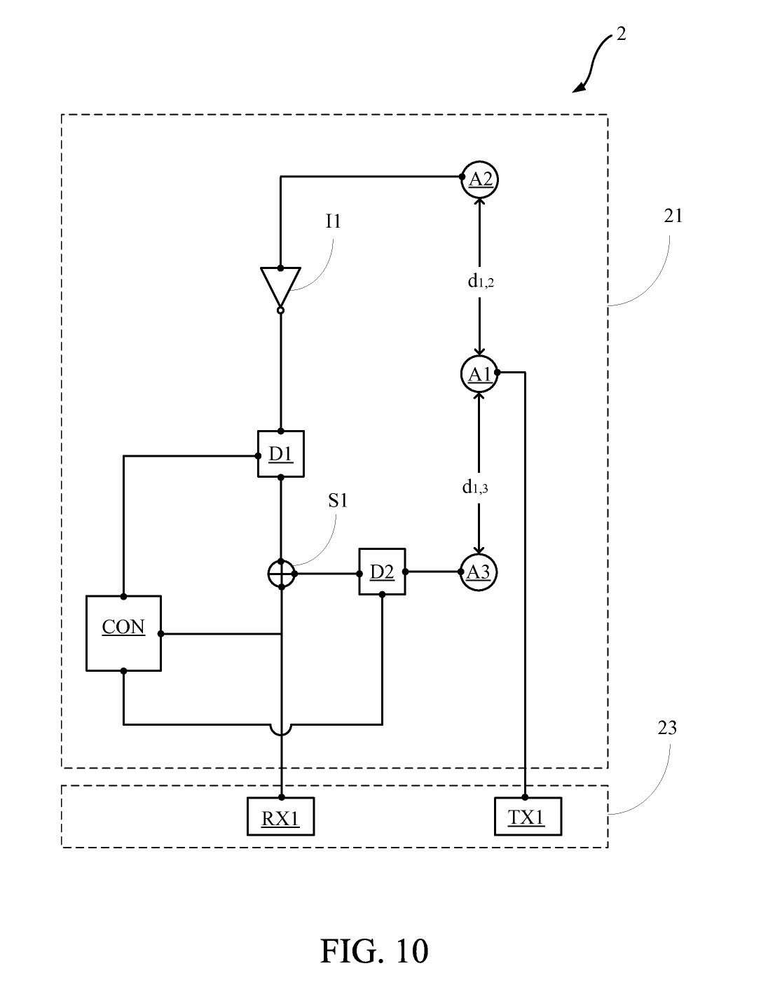

A tenth embodiment of the present invention is shown in FIG. 10, which is an extension of the seventh embodiment. Similarly, to solve the problem that the self-interference cannot be eliminated due to positional errors of the antennas in practice, a controller CON, a first delayer D1 and a second delayer D2 are additionally disposed in the antenna module 21 of the seventh embodiment. The second antenna A2 is coupled to the first receive feeding point RX1 via the first inverter I1, the first adder S1 and the first delayer D1, and the third antenna A3 is coupled to the first receive feeding point RX1 via the second delayer D2 and the first adder S1.

Similarly, when d_{1,2} and d_{1,3} are actually different from each other and have a distance difference Δd therebetween, a test signal can be transmitted in the present invention so that the controller CON calculates a correction value according to the received signal received at the first receive feeding point RX1 and, according to the correction value, adjusts the delay value t1 of the first delayer D1 and the delay value t2 of the second delayer D2 to compensate for the distance difference Δd between d_{1,2} and d_{1,3}. Then, even if there is actually a distance difference Δd between d_{1,2} and d_{1,3}, the first received signal received by the second antenna A2 and the first received signal received by the third antenna A3 can also arrive at the first adder S1 at the same time to eliminate the self-interference at the first receive feeding point RX1. In this embodiment, the controller CON is disposed in the antenna module 21 to adjust the delayers; however, the controller CON may also be disposed in the FDR transceiver 23 or be further integrated in an RF chip of the FDR transceiver 23 in other embodiments, and these variations all fall within the scope of the present invention.

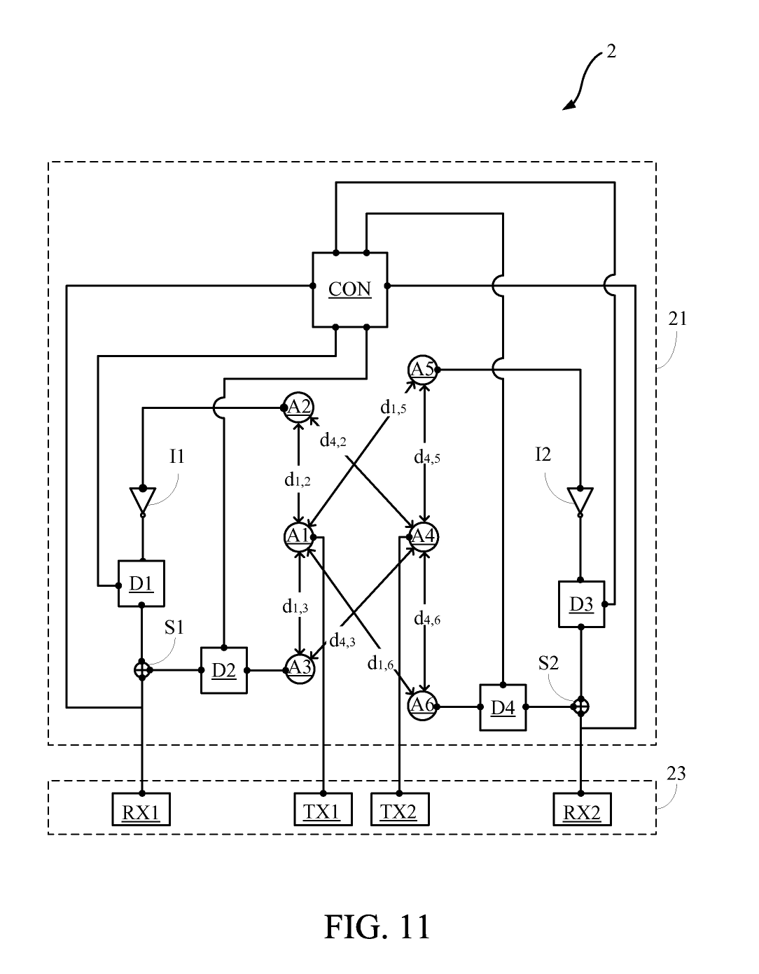

An eleventh embodiment of the present invention is shown in FIG. 11, which is an extension of the ninth embodiment. Similarly, to solve the problem that the self-interference to the received signal cannot be cancelled due to positional errors of the antennas in practice, the antenna module 21 of this embodiment further comprises a controller CON, a first delayer D1, a second delayer D2, a third delayer D3 and a fourth delayer D4. The second antenna A2 is coupled to the first receive feeding point RX1 via the first inverter I1, the first delayer D1 and the first adder S1, the third antenna A3 is coupled to the first receive feeding point RX1 via the second delayer D2 and the first adder S1, the fifth antenna A5 is coupled to the second receive feeding point RX2 via the second inverter I2, the third delayer D3 and the second adder S2, and the sixth antenna A6 is coupled to the second receive feeding point RX2 via the fourth delayer D4 and the second adder S2.

The controller CON is coupled to the first delayer D1, the second delayer D2, the third delayer D3, the fourth delayer D4, the first receive feeding point RX1 and the second receive feeding point RX2, and is configured to adjust a delay value t1 of the first delayer D1, a delay value t2 of the second delayer D2, a delay value t3 of the third delayer D3 and a delay value t4 of the fourth delayer D4 according to the first received signal and the second received signal.

Specifically, in this embodiment, there is actually a distance difference Δd1 between d_{1,2} and d_{1,3}, a distance difference Δd2 between d_{1,5} and d_{1,6}, a distance difference Δd3 between d_{4,2} and d_{4,3}, and a distance difference Δd4 between d_{4,5} and d_{4,6}. In practice, it is impossible to compensate for the distance differences Δd1, Δd2, Δd3 and Δd4 simultaneously so as to perfectly eliminate the self-interference at the first receive feeding point RX1 and the second receive feeding point RX2. Therefore, in the present invention, the delay values t1, t2, t3 and t4 are decided according to an energy sum value of the first received signal received at the first receive feeding point RX1 and the second received signal received at the second received feeding point RX2 at a correction stage in such a way that the energy sum value of the first received signal and the second received signal is minimized to minimize the self-interference.

Similarly, the controller CON may be designed to calculate optimal delay values t1, t2, t3 and t4 according to the genetic algorithm (GA), the Particle Swarm Optimization (PSO) algorithm, the Asynchronous Particle Swarm Optimization (APSO) algorithm, the Dynamic Differential Evolution (DDE) algorithm or some other similar algorithm to make Rp minimized, where Rp=Rs₁²+Rs₂² is the energy sum value, Rs₁ is the first received signal and Rs₂ is the second received signal. As how the delay values t1, t2, t3 and t4 are calculated according to an appropriate algorithm to minimize the self-interferences will be readily appreciated by those of ordinary skill in the art, this will not be further described herein.

It shall be further appreciated that, for purpose of simplicity, the aforesaid embodiments only describe aspects in which one set of transmit antennas is used in combination with one set of receive antennas, two sets of transmit antennas are used in combination with one set of receive antennas, and two sets of transmit antennas are used in combination with two sets of receive antennas; however, those of ordinary skill in the art can readily appreciate from the aforesaid embodiments that aspects in which any number of sets of transmit antennas are used in combination with any number of sets of receive antennas can be achieved in the present invention so long as every two antennas in each set of transmit antennas have substantially the same distance from an antenna in each set of receive antennas, and this will not be further described herein. Furthermore, the controller CON is disposed in the antenna module 21 in this embodiment to adjust the delayers; however, the controller CON may also be disposed in the FDR transceiver 23 or be further integrated in an RF chip of the FDR transceiver 23 in other embodiments, and these variations all fall within the scope of the present invention.

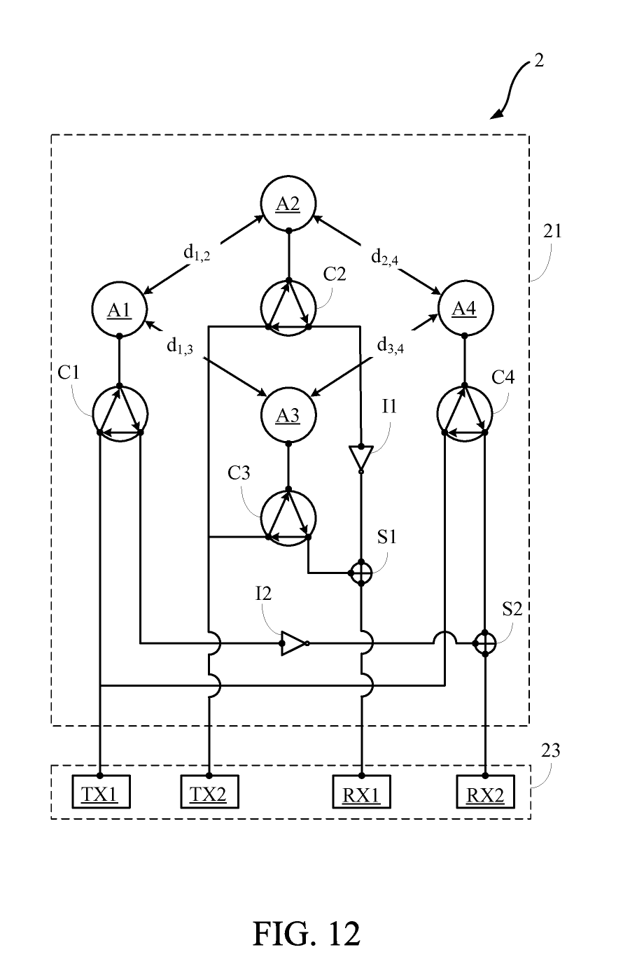

A twelfth embodiment of the present invention is shown in FIG. 12, which is an extension of the seventh embodiment. In this embodiment, the FDR transceiver 23 further comprises a second transmit feeding point TX2 configured to transmit a second transmit signal and a second receive feeding point RX2 configured to receive a second receive signal. The antenna module 21 further comprises a fourth antenna A4, a second inverter I2, a second adder S2, a first circulator C1, a second circulator C2, a third circulator C3 and a fourth circulator C4. Each of the circulators has a first port, a second port and a third port.

In this embodiment, each antenna also serves to both transmit a signal and receive a signal at a same time. For each of the circulators, the first port is coupled to a transmit feeding point, the second port is coupled to an antenna and the third port is coupled to a receive feeding point. Because the device property of the circulators is well known in the art, so it will not be further described herein. Additionally, this embodiment has a signal at the third port of one of the circulators of a same set of transmit and receive antennas inverted by an inverter and then added to the signal at another third port via an adder. This not only minimizes the self-interferences at the receive feeding point, but also solves the problems of signal leakage between the first port and the third port of the circulators and the mutual interference between transmitted signals of a same set of transmit antenna and receive antenna.

Specifically, for the first circulator C1, the first port is coupled to the first transmit feeding point TX1, the second port is coupled to the first antenna A1, and the third port is coupled to the second receive feeding point RX2 via the second inverter I2 and the second adder S2 so that the first antenna A1 is coupled to the first transmit feeding point TX1 and the second receive feeding point RX2 respectively via the first circulator C1. For the second circulator C2, the first port is coupled to the second transmit feeding point TX2, the second port is coupled to the second antenna A2, and the third port is coupled to the first receive feeding point RX1 via the first inverter I1 and the first adder S1 so that the second antenna A2 is coupled to the second transmit feeding point TX2 and the first receive feeding point RX1 respectively via the second circulator C2.

For the third circulator C3, the first port is coupled to the second transmit feeding point TX2, the second port is coupled to the third antenna A3, and the third port is coupled to the first receive feeding point RX1 via the first adder S1 so that the third antenna A3 is coupled to the second transmit feeding point TX2 and the first receive feeding point RX1 via the third circulator C3. For the fourth circulator C4, the first port is coupled to the first transmit feeding point TX1 via the first port, the second port is coupled to the fourth antenna A4, and the third port is coupled to the second receive feeding point RX2 via the second adder S2 so that the fourth antenna A4 is coupled to the first transmit feeding point TX1 and the second receive feeding point RX2 respectively via the fourth circulator C4.

The first antenna A1 and the second antenna A2 have a distance d_{1,2} therebetween, and the first antenna A1 and the third antenna A3 have a distance d_{1,3} therebetween. Similarly, to eliminate the self-interference to the first received signal received at the first receive feeding point RX1 and the second received signal received at the second receive feeding point RX2, the antennas in this embodiment are disposed in such a way that a distance difference between d_{1,2} and d_{1,3} is substantially 0, and a distance difference between d_{2,4} and d_{3,4} is substantially 0. It shall be appreciated that, as in the eleventh embodiment, delayers may be additionally disposed in this embodiment to compensate for the positional errors of the antennas through correction so as to minimize the self-interference; and because how the delayers are disposed for correction will be readily appreciated from the eleventh embodiment by those of ordinary skill in the art, this will not be further described herein.

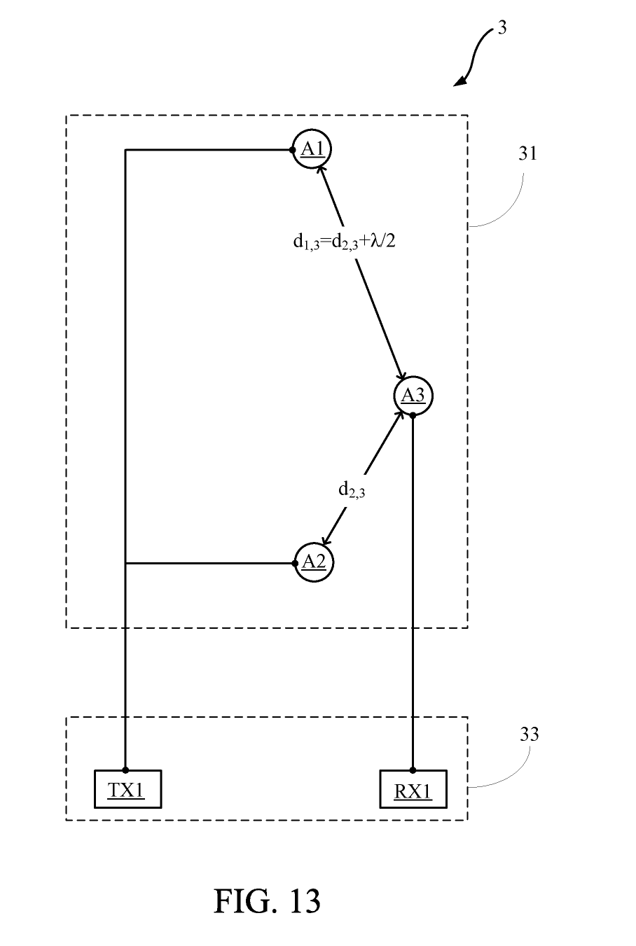

A thirteenth embodiment of the present invention is shown in FIG. 13, which is a schematic view of a wireless device 3 of the present invention. The wireless device 3 comprises an antenna module 31 and an FDR transceiver 33. The FDR transceiver 33 comprises a first transmit feeding point TX1 configured to transmit a first transmitted signal and a first receive feeding point RX1 configured to receive a first received signal. The antenna module 31 comprises a first antenna A1, a second antenna A2 and a third antenna A3. The first antenna A1 and the second antenna A2 are both coupled to the first transmit feeding point TX1. The third antenna A3 is coupled to the first receive feeding point RX1.

The first antenna A1 and the second antenna A3 have a distance d_{1,3} therebetween, and the second antenna A2 and the third antenna A3 have a distance d_{2,3} therebetween. A distance difference between d_{1,3} and d_{2,3} is substantially λ/2, where λ is a wavelength corresponding to an operation frequency of the FDR transceiver 33. Unlike the previous embodiments, this embodiment eliminates the interference to the received signal from the transmitted signals by transmitting the transmitted signals from different transmit antennas to the receive antenna with a transmission distance difference of λ/2 therebetween so that the opposite transmitted signals arriving at the receive antenna (i.e., transmitted signals transmitted by two transmit antennas respectively) are in opposite phase to each other (i.e., having a phase difference of 180°).

It shall be appreciated that, those of ordinary skill in the art can readily appreciate from the above descriptions that the opposite transmitted signals representing a same symbol will not be entirely overlapped with each other due to the transmission distance difference of λ/2. Accordingly, as compared with the implementation in which the antennas are disposed to have a same transmission distance, this embodiment is more suitable for the orthogonal frequency-division multiplexing (OFDM) communication system or a communication system where a guard interval is provided between symbols.

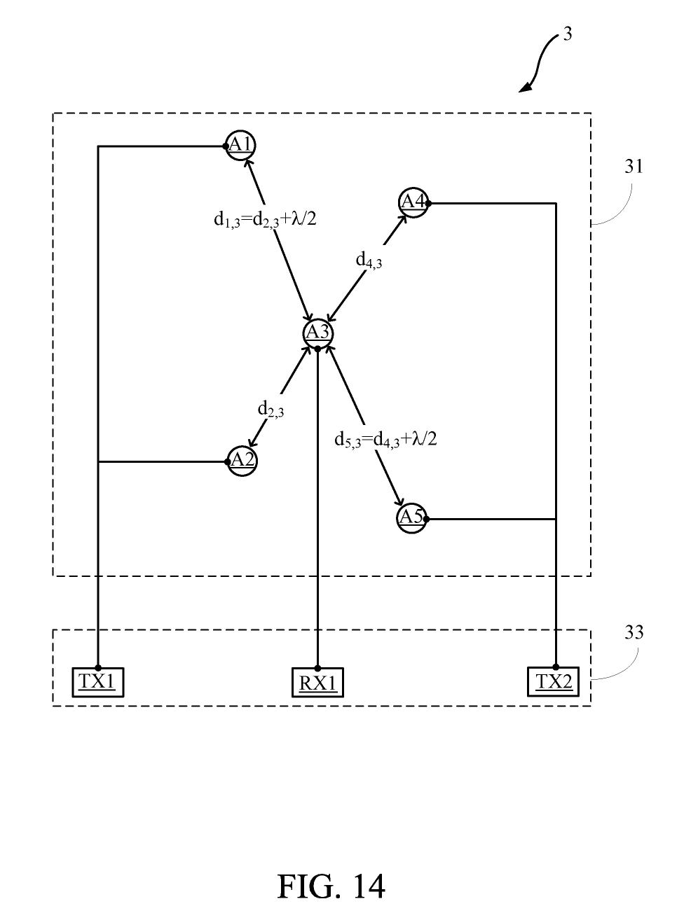

A fourteenth embodiment of the present invention is shown in FIG. 14, which is an extension of the thirteenth embodiment. In this embodiment, the FDR transceiver 33 further comprises a second transmit feeding point TX2 configured to transmit a second transmit signal. The antenna module 31 further comprises a fourth antenna A4 and a fifth antenna A5. The fourth antenna A4 and the fifth antenna A5 are both coupled to the second transmit feeding point TX2. The fourth antenna A4 and the third antenna A3 have a distance d_{4,3} therebetween, and the fifth antenna A5 and the third antenna A3 have a distance d_{5,3} therebetween. A distance difference between d_{4,3} and d_{5,3} is substantially λ/2, so a component of the second transmitted signal transmitted by the fourth antenna A4 at the third antenna A3 and that of the second transmitted signal transmitted by the fifth antenna A5 at the third antenna A3 are offset by each other to eliminate the self-interference to the first received signal at the first receive feeding point RX1.

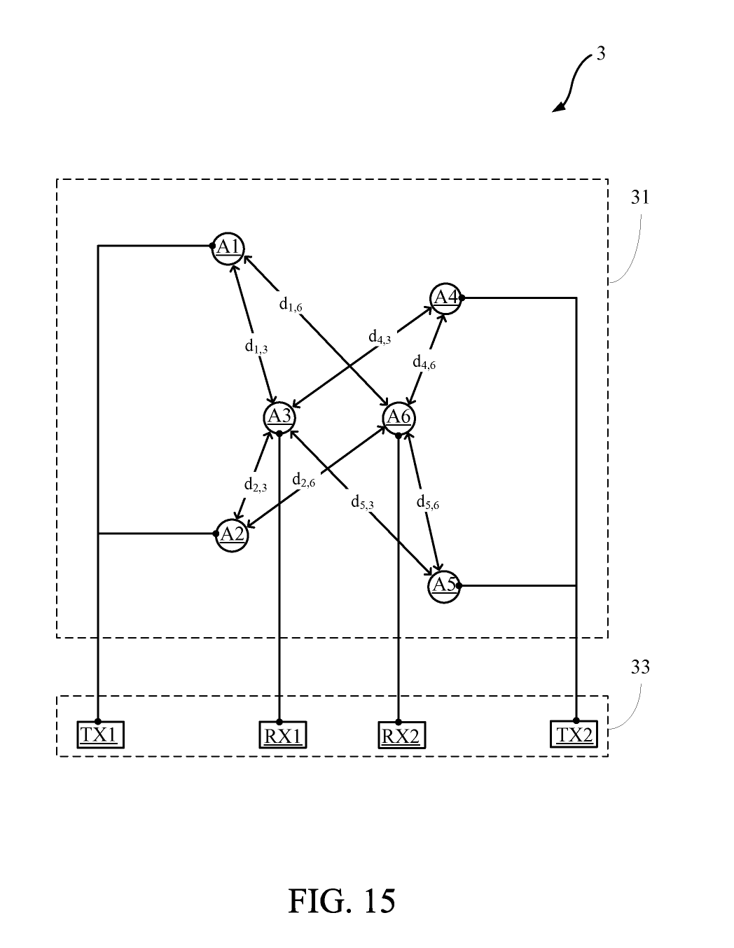

A fifteenth embodiment of the present invention is shown in FIG. 15, which is an extension of the fourteenth embodiment. In this embodiment, the FDR transceiver 33 further comprises a second receive feeding point RX2 configured to receive a second transmit signal. The antenna module 31 further comprises a sixth antenna A6 coupled to the second receive feeding point RX2. The first antenna A1 and the sixth antenna A6 have a distance d_{1,6} therebetween, the second antenna A1 and the sixth antenna A6 have a distance d_{2,6} therebetween, the fourth antenna A4 and the sixth antenna A6 have a distance d_{4,6} therebetween, and the fifth antenna A5 and the sixth antenna A6 have a distance d_{5,6} therebetween.

A distance difference between d_{1,6} and d_{2,6} is substantially λ/2 and a distance difference between d_{4,6} and d_{5,6} is substantially λ/2, so a component of the first transmitted signal transmitted by the first antenna A1 that is received at the sixth antenna A6 and that of the first transmitted signal transmitted by the second antenna A2 that is received at the sixth antenna A6 are offset by each other and a component of the second transmitted signal transmitted by the fourth antenna A4 that is received at the sixth antenna A6 and that of the second transmitted signal transmitted by the fifth antenna A5 that is received at the sixth antenna A6 are offset by each other to eliminate the self-interference to the second received signal at the second receive feeding point RX2.

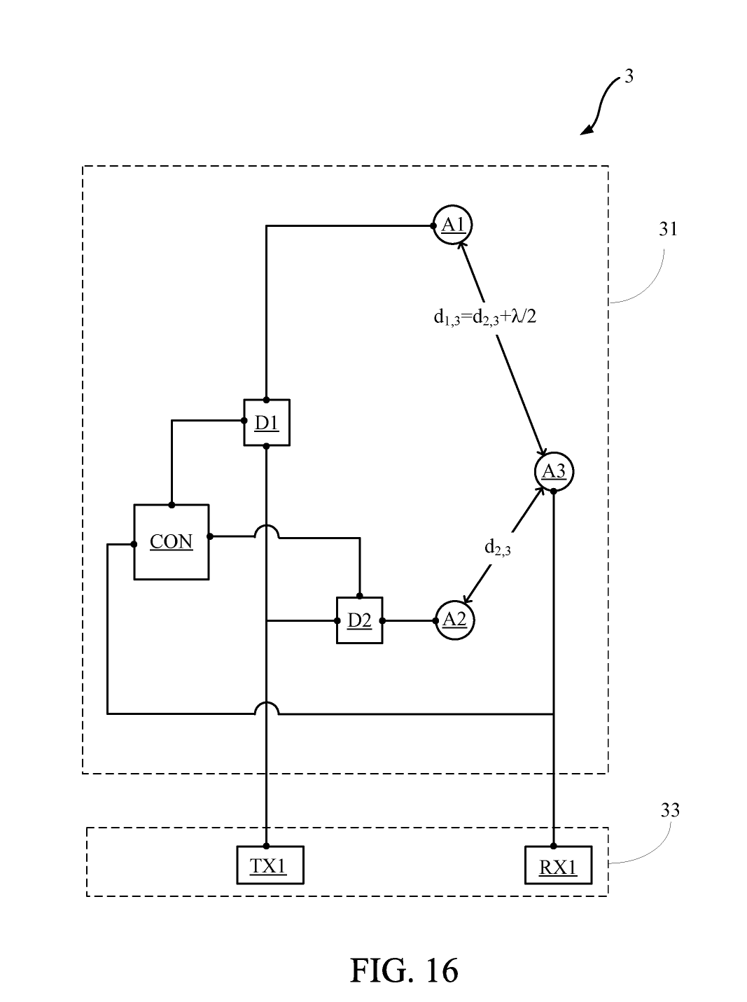

A sixteenth embodiment of the present invention is shown in FIG. 16, which is an extension of the thirteenth embodiment. In this embodiment, to solve the problem that the self-interference to the received signal cannot be cancelled due to positional errors of the antennas in practice, the antenna module 31 further comprises a controller CON, a first delayer D1 and a second delayer D2. The first antenna A1 is coupled to the first transmit feeding point TX1 via the first delayer D1, and the second antenna A2 is coupled to the first transmit feeding point TX1 via the second delayer D2.

The controller CON is coupled to the first delayer D1, the second delayer D2 and the first receive feeding point RX1, and is configured to adjust a delay value t1 of the first delayer D1 and a delay value t2 of the second delayer D2 according to the first received signal so as to compensate for the distance difference Δd. Then, even if there is actually a distance difference κ/2+Δd between d_{1,3} and d_{2,3}, the present invention can still eliminate the self-interference at the first receive feeding point RX1 by having the first transmitted signal transmitted by the first antenna A1 and the first transmitted signal transmitted by the second antenna A2 arrive at the third antenna A3 with a transmission distance difference of λ/2 therebetween so that components of the first transmitted signals arriving at the third antenna A3 are offset by each other.

It shall be appreciated that, the delayers are time delayers in this embodiment; however, the delayers may also be phase retarders in other embodiments. Furthermore, the controller CON is disposed in the antenna module 31 in this embodiment to adjust the delayers; however, the controller CON may also be disposed in the FDR transceiver 33 or be further integrated in an RF chip of the FDR transceiver 33 in other embodiments, and these variations all fall within the scope of the present invention.

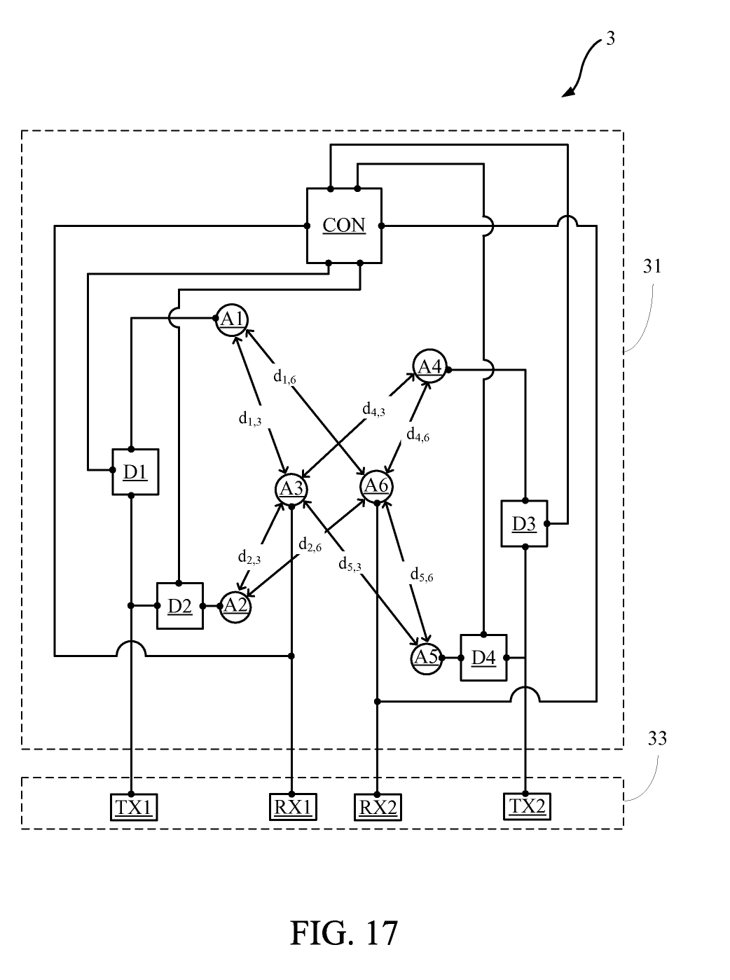

A seventeenth embodiment of the present invention is shown in FIG. 17, which is an extension of the fifteenth embodiment. Similarly, to solve the problem that the self-interference to the received signal cannot be cancelled due to positional errors of the antennas in practice, the antenna module 31 further comprises a controller CON, a first delayer D1, a second delayer D2, a third delayer D3 and a fourth delayer D4. The first antenna A1 is coupled to the first transmit feeding point TX1 via the first delayer D1, the second antenna A2 is coupled to the first transmit feeding point TX1 via the second delayer D2, the fourth antenna A4 is coupled to the second transmit feeding point TX2 via the third delayer D3, and the fifth antenna A5 is coupled to the second transmit feeding point TX2 via the fourth delayer D4.

The controller CON adjusts a delay value t1 of the first delayer D1, a delay value t2 of the second delayer D2, a delay value t3 of the third delayer D3 and a the delay value t4 of the fourth delayer D4 according to the first received signal and the second received signal. Specifically, in this embodiment, there is actually a distance difference λ/2+Δd1 between d_{1,3} and d_{2,3}, a distance difference λ/2+Δd2 between d_{4,3} and d_{5,3}, a distance difference λ/2+Δd3 between d_{1,6} and d_{2,6}, and a distance difference λ/2+Δd4 between d_{1,6} and d_{2,6}. In practice, it is impossible to compensate for the distance differences Δd1, Δd2, Δd3 and Δd4 simultaneously so as to perfectly eliminate the self-interferences at the first receive feeding point RX1 and the second receive feeding point RX2 simultaneously. Therefore, in the present invention, the delay values t1, t2, t3 and t4 are decided according to an energy sum value of the first received signal received at the first receive feeding point RX1 and the second received signal received at the second received feeding point RX2 at a correction stage in such a way that the energy sum value of the first received signal and the second received signal is minimized to minimize the self-interferences.

As described above, the controller CON of the present invention can be designed to calculate optimal delay values t1, t2, t3 and t4 according to the genetic algorithm (GA), the Particle Swarm Optimization (PSO) algorithm, the Asynchronous Particle Swarm Optimization (APSO) algorithm, the Dynamic Differential Evolution (DDE) algorithm or some other similar algorithm to make Rp=Rs₁²+Rs₂² minimized, where Rp is the energy sum value, Rs₁ is the first received signal and Rs₂ is the second received signal. As how the delay values t1, t2, t3 and t4 are calculated according to an appropriate algorithm to minimize the self-interferences will be readily appreciated by those of ordinary skill in the art, this will not be further described herein.

It shall be further appreciated that, for purpose of simplicity, the aforesaid embodiments only describe aspects in which one set of transmit antennas is used in combination with one set of receive antennas, two sets of transmit antennas are used in combination with one set of receive antennas, and two sets of transmit antennas are used in combination with two sets of receive antennas; however, those of ordinary skill in the art can readily appreciate from the aforesaid embodiments that aspects in which any number of transmit antennas are used in combination with any number of receive antennas can be achieved in the present invention so long as two antennas in each set of transmit antennas have a distance difference of λ/2 from an antenna in each set of receive antennas, and this will not be further described herein. Furthermore, the controller CON is disposed in the antenna module 31 in this embodiment to adjust the delayers; however, the controller CON may also be disposed in the FDR transceiver 33 or be further integrated in an RF chip of the FDR transceiver 33 in other embodiments, and these variations all fall within the scope of the present invention.

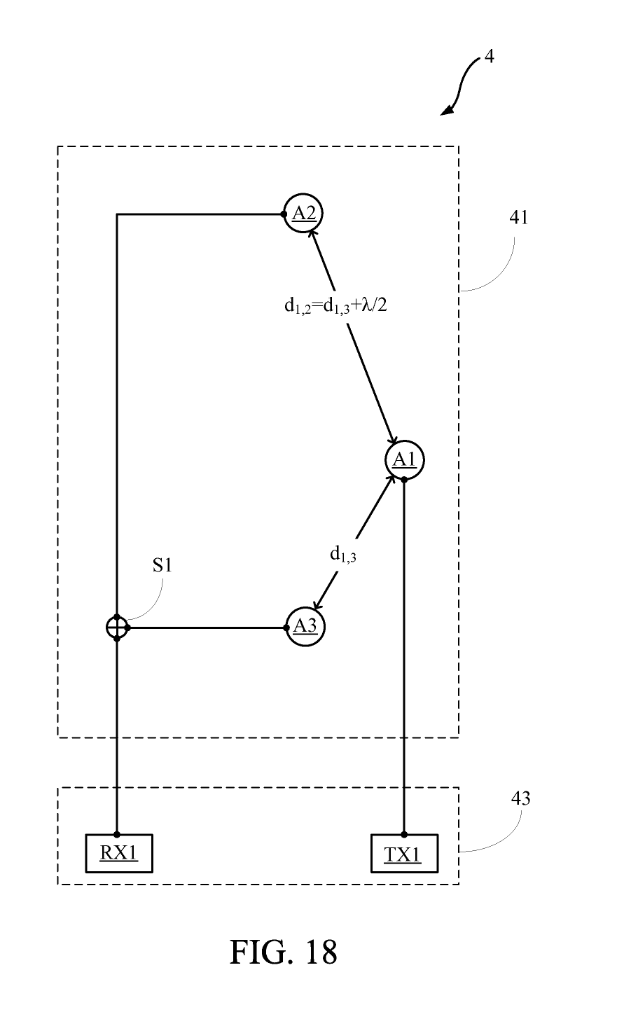

An eighteenth embodiment of the present invention is shown in FIG. 18, which is a schematic view of a wireless device 4 of the present invention. The wireless device 4 comprises an antenna module 41 and an FDR transceiver 43, and the antenna module 41 is coupled to the FDR transceiver 43. The FDR transceiver 43 comprises a first transmit feeding point TX1 configured to transmit a first transmitted signal and a first receive feeding point RX1 configured to receive a first received signal. The antenna module 41 comprises a first adder S1, a first antenna A1, a second antenna A2 and a third antenna A3. The first antenna A1 is coupled to the first transmit feeding point TX1. The second antenna A2 and the third antenna A3 is coupled to the first receive feeding point RX1 via the first adder S1. The first antenna A1 and the second antenna A2 have a distance d_{1,2} therebetween, and the first antenna A1 and the third antenna A3 have a distance d_{1,3} therebetween. A distance difference d_{1,2} and d_{1,3} is substantially λ/2, where λ is a wavelength corresponding to an operation frequency of the FDR transceiver 43.

Specifically, because the distance difference d_{1,2} and d_{1,3} is substantially λ/2, the first transmitted signal received by the second antenna A2 and the first transmitted signal received by the third antenna A3 from the first antenna A1 respectively have phases opposite to each other. Because of this, the first transmitted signal component in the first received signal can be removed by adding the signal received by the second antenna A2 and the signal received by the third antenna A3 together.

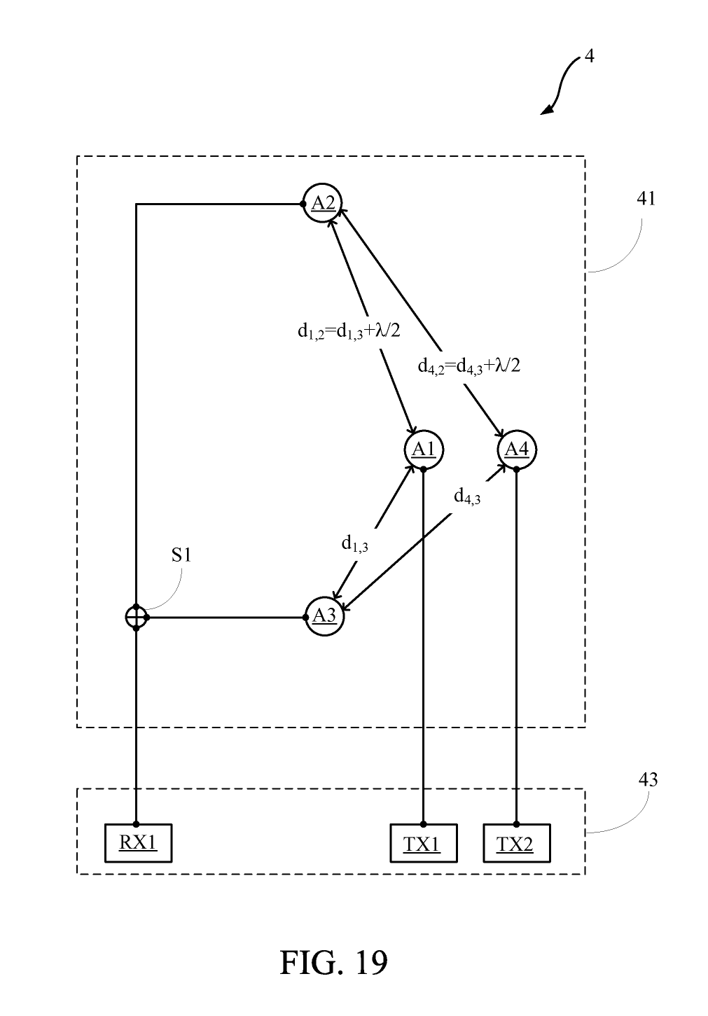

A nineteenth embodiment of the present invention is shown in FIG. 19, which is an extension of the eighteenth embodiment. The FDR transceiver 43 further comprises a second transmit feeding point TX2 configured to transmit a second transmitted signal. The antenna module 41 further comprises a fourth antenna A4. The fourth antenna A4 is coupled to the second transmit feeding point TX2. The fourth antenna A4 and the second antenna A2 have a distance d_{4,2} therebetween, and the fourth antenna A4 and the third antenna A3 have a distance d_{4,3} therebetween. Similarly, to eliminate the self-interference to the first received signal at the first receive feeding point RX1, d_{4,2} and d_{4,3} are designed to have a distance difference of λ/2 (i.e., the distance difference between d_{4,2} and d_{4,3} is substantially λ/2) in this embodiment.

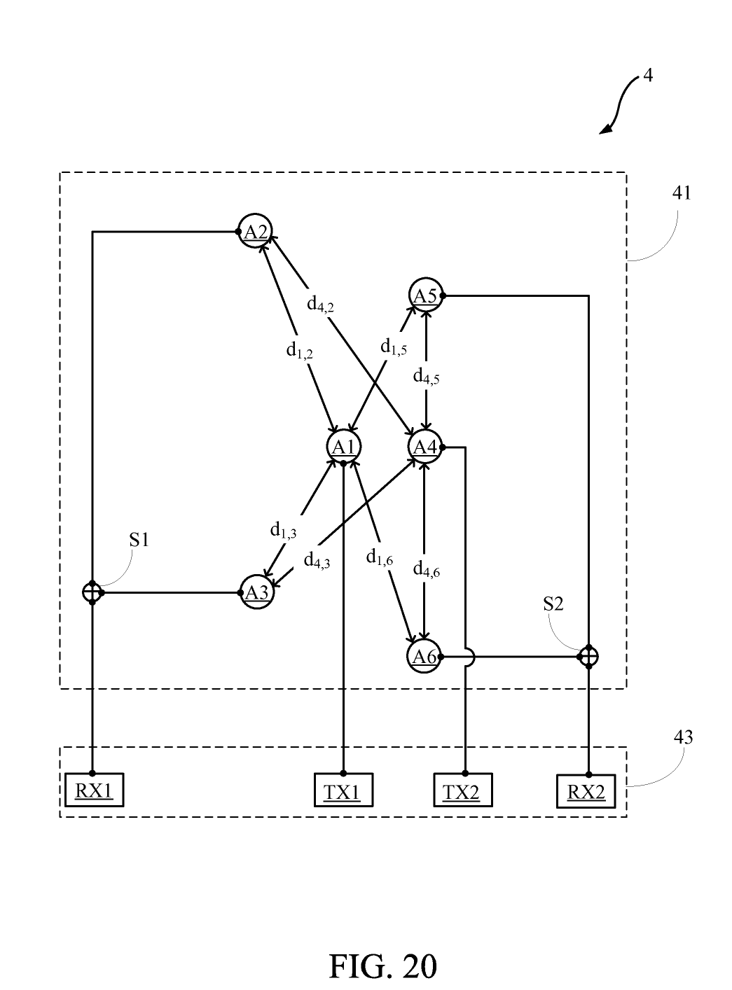

A twentieth embodiment of the present invention is shown in FIG. 20, which is an extension of the nineteenth embodiment. The FDR transceiver 43 further comprises a second receive feeding point RX2 configured to receive a second received signal. The antenna module 41 further comprises a second adder S2, a fifth antenna A5 and a sixth antenna A6, and the fifth antenna A5 and the sixth antenna A6 are both coupled to the second receive feeding point RX2 via the second adder S2. The first antenna A1 and the fifth antenna A5 have a distance d_{1,5} therebetween, the first antenna A1 and the sixth antenna A6 have a distance d_{1,6} therebetween, the fourth antenna A4 and the fifth antenna A5 have a distance d_{4,5} therebetween, and the fourth antenna A4 and the sixth antenna A6 have a distance d_{4,6} therebetween.

Similarly, to eliminate the self-interference to the second received signal at the second receive feeding point RX2, d_{1,5} and d_{1,6} are designed to have a distance difference of λ/2 (i.e., a distance difference between d_{1,5} and d_{1,6} is substantially λ/2) and d_{4,5} and d_{4,6} are designed to have a distance difference of λ/2 (i.e., a distance difference between d_{4,5} and d_{4,6} is substantially λ/2) in this embodiment.

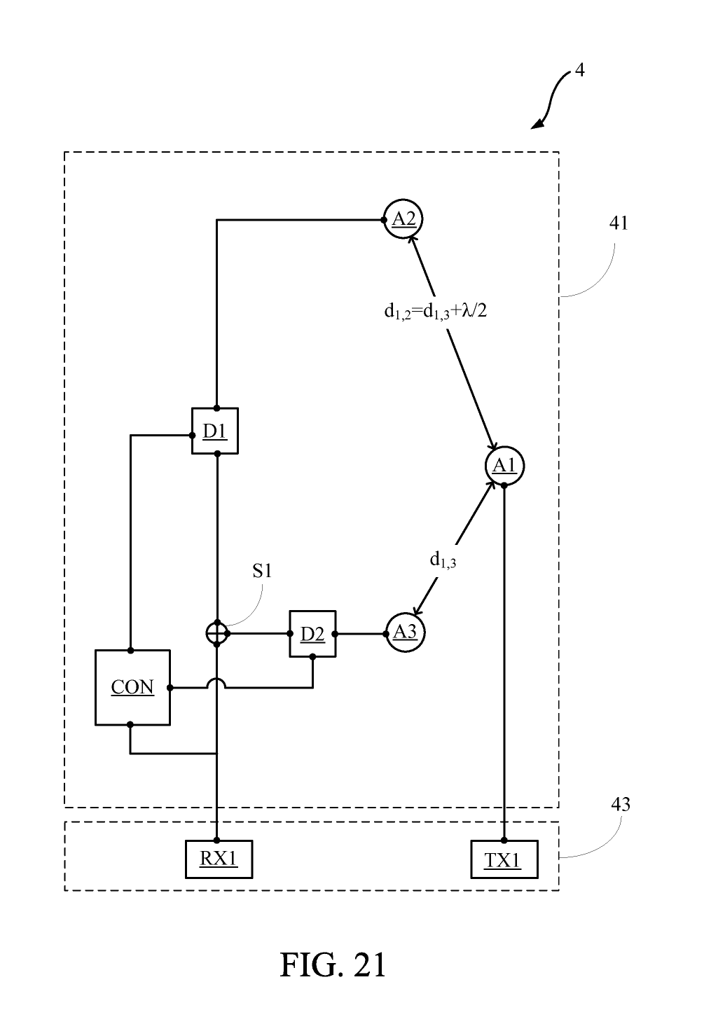

A twenty-first embodiment of the present invention is shown in FIG. 21, which is an extension of the eighteenth embodiment. Similarly, to solve the problem that the self-interference cannot be eliminated due to positional errors of the antennas in practice, a controller CON, a first delayer D1 and a second delayer D2 are additionally disposed in the antenna module 41. The second antenna A2 is coupled to the first receive feeding point RX1 via the first delayer D1 and the first adder S1, and the third antenna A3 is coupled to the first receive feeding point RX1 via the second delayer D2 and the first adder S1.

Similarly, when d_{1,2} and d_{1,3} actually have a distance difference λ/2+Δd therebetween, a test signal can be transmitted in the present invention so that the controller CON calculates a correction value according to the received signal received at the first receive feeding point RX1 and, according to the correction value, adjusts the delay value t1 of the first delayer D1 and the delay value t2 of the second delayer D2 to compensate for the distance difference λ/2+Δd between d_{1,2} and d_{1,3}. Then, even if there is actually a distance difference λ/2+Δd between d_{1,2} and d_{1,3}, the first received signal received by the second antenna A2 and the first received signal received by the third antenna A3 can also arrive at the first adder S1 with a transmission distance difference of λ/2 therebetween to eliminate the self-interference at the first receive feeding point RX1. In this embodiment, the controller CON is disposed in the antenna module 41 to adjust the delayers; however, the controller CON may also be disposed in the FDR transceiver 43 or be further integrated in an RF chip of the FDR transceiver 43 in other embodiments, and these variations all fall within the scope of the present invention.

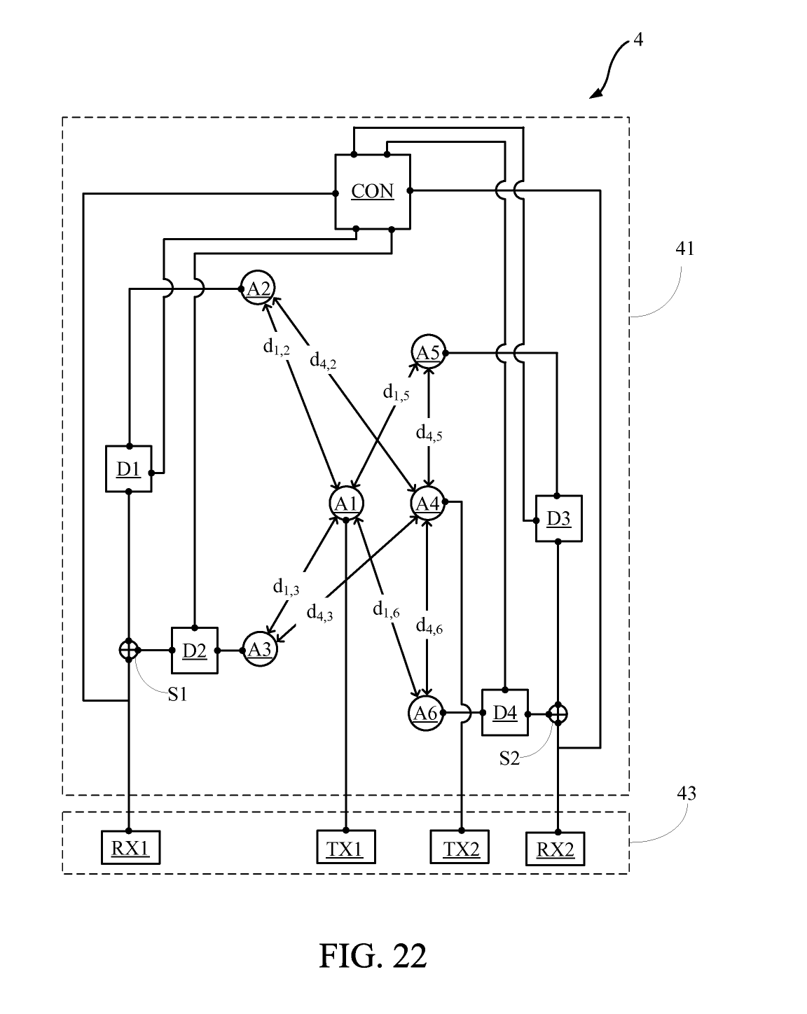

A twenty-second embodiment of the present invention is shown in FIG. 22, which is an extension of the twentieth embodiment. In this embodiment, the antenna module 41 further comprises a controller CON, a first delayer D1, a second delayer D2, a third delayer D3 and a fourth delayer D4. The second antenna A2 is coupled to the first receive feeding point RX1 via the first delayer D1 and the first adder S1, the third antenna A3 is coupled to the first receive feeding point RX1 via the second delayer D2 and the first adder S1, the fifth antenna A5 is coupled to the second receive feeding point RX2 via the third delayer D3 and the second adder S2, and the sixth antenna A6 is coupled to the second receive feeding point RX2 via the fourth delayer D4 and the second adder S2.

The controller CON is configured to adjust a delay value t1 of the first delayer D1, a delay value t2 of the second delayer D2, a delay value t3 of the third delayer D3 and a delay value t4 of the fourth delayer D4 according to the first received signal and the second received signal. Specifically, in this embodiment, there is actually a distance difference of λ/2+Δd1 between d_{1,2} and d_{1,3}, a distance difference of λ/2+Δd2 between d_{1,5} and d_{1,6}, a distance difference of λ/2+Δd3 between d_{4,2} and d_{4,3}, and a distance difference of λ/2+Δd4 between 45 and d_{4,6}. In practice, it is impossible to compensate for the distance differences Δd1, Δd2, Δd3 and Δd4 simultaneously so as to perfectly eliminate the self-interference at the first receive feeding point RX1 and the second receive feeding point RX2 simultaneously. Therefore, in the present invention, the delay values t1, t2, t3 and t4 are decided according to an energy sum value of the first received signal received at the first receive feeding point RX1 and the second received signal received at the second received feeding point RX2 at a correction stage in such a way that the energy sum value of the first received signal and the second received signal is minimized to minimize the self-interferences.

As described above, the controller CON may be designed to calculate optimal delay values t1, t2, t3 and t4 according to the genetic algorithm (GA), the Particle Swarm Optimization (PSO) algorithm, the Asynchronous Particle Swarm Optimization (APSO) algorithm, the Dynamic Differential Evolution (DDE) algorithm or some other similar algorithm to make Rp minimized, where Rp=Rs₁²+Rs₂² is the energy sum value, Rs₁ is the first received signal and Rs₂ is the second received signal. As how the delay values t1, t2, t3 and t4 are calculated according to an appropriate algorithm to minimize the self-interferences will be readily appreciated by those of ordinary skill in the art, this will not be further described herein.

It shall be further appreciated that, for purpose of simplicity, the aforesaid embodiments only describe aspects in which one set of transmit antennas is used in combination with one set of receive antennas, two sets of transmit antennas are used in combination with one set of receive antennas, and two sets of transmit antennas are used in combination with two sets of receive antennas; however, those of ordinary skill in the art can readily appreciate from the aforesaid embodiments that aspects in which any number of sets of transmit antennas are used in combination with any number of sets of receive antennas can be achieved in the present invention so long as every two antennas in each set of transmit antennas have a distance difference of λ/2 from an antenna in each set of receive antennas, and this will not be further described herein. Furthermore, the controller CON is disposed in the antenna module 41 in this embodiment to adjust the delayers; however, the controller CON may also be disposed in the FDR transceiver 43 or be further integrated in an RF chip of the FDR transceiver 43 in other embodiments, and these variations all fall within the scope of the present invention.

According to the above descriptions, through arrangement of antennas, the wireless device of the present invention can cancel the self-interference to the received signal from the transmitted signal so that signal transmissions can be done in the FDR framework.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless device, comprising:
a full duplex radios (FDR) transceiver, comprising a first transmit feeding point and a first receive feeding point, and being configured to transmit a first transmitted signal from the first transmit feeding point and receive a first received signal from the first receive feeding point;
an antenna module, comprising:
a first inverter;
a first antenna coupled to the first transmit feeding point via the first inverter;
a second antenna coupled to the first transmit feeding point; and
a third antenna coupled to the first receive feeding point;
wherein the first antenna and the third antenna have a distance d_{1,3} therebetween, the second antenna and the third antenna have a distance d_{2,3} therebetween, and a distance difference between d_{1,3} and d_{2,3} is substantially 0.

2. The wireless device of claim 1, wherein the antenna module further comprises a controller, a first delayer and a second delayer, the controller is coupled to the first delayer, the second delayer and the first receive feeding point and is configured to adjust a delay value of the first delayer and a delay value of the second delayer according to the first received signal, the first antenna is coupled to the first transmit feeding point via the first delayer and the first inverter, and the second antenna is coupled to the first transmit feeding point via the second delayer and the first inverter.

3. The wireless device of claim 1, wherein:
the FDR transceiver further comprises a second transmit feeding point and is further configured to transmit a second transmitted signal from the second transmit feeding point;
the antenna module further comprises:
a second inverter;
a fourth antenna coupled to the second transmit feeding point via the second inverter; and
a fifth antenna coupled to the second transmit feeding point;
wherein the fourth antenna and the third antenna have a distance d_{4,3} therebetween, the fifth antenna and the third antenna have a distance d_{5,3} therebetween, and a distance difference between d_{4,3} and d_{5,3} is substantially 0.

4. The wireless device of claim 3, wherein:
the FDR transceiver further comprises a second receive feeding point, and is further configured to receive a second received signal from the second receive feeding point;
the antenna module further comprises a sixth antenna coupled to the second receive feeding point;
wherein the first antenna and the sixth antenna have a distance d_{1,6} therebetween, the second antenna and the sixth antenna have a distance d_{2,6} therebetween, the fourth antenna and the sixth antenna have a distance d_{4,6} therebetween, the fifth antenna and the sixth antenna have a distance d_{5,6} therebetween, a distance difference between d_{1,6} and d_{2,6} is substantially 0, and a distance difference between d_{4,6} and d_{5,6} is substantially 0.

5. The wireless device of claim 4, wherein the antenna module further comprises a controller, a first delayer, a second delayer, a third delayer and a fourth delayer, the controller is coupled to the first delayer, the second delayer, the third delayer, the fourth delayer, the first receive feeding point and the second receive feeding point and is configured to adjust a delay value of the first delayer, a delay value of the second delayer, a delay value of the third delayer and a delay value of the fourth delayer according to the first received signal and the second received signal, the first antenna is coupled to the first transmission feeding point via the first delayer and the first inverter, the second antenna is coupled to the first transmit feeding point via the second delayer, and the fourth antenna is coupled to the second transmit feeding point via the third delayer and the second inverter, and the fifth antenna is coupled to the second transmit feeding point via the fourth delayer.

6. The wireless device of claim 1, wherein:
the FDR transceiver further comprises a second transmit feeding point and a second receive feeding point and is configured to transmit a second transmitted signal from the second transmit feeding point and receive a second received signal from the second receive feeding point;
the antenna module further comprises:
a first adder;
a second adder;
a second inverter;
a fourth antenna; and
a first circulator having a first port, a second port and a third port, the first port being coupled to the first transmit feeding point via the first inverter, the second port being coupled to the first antenna, and the third port being coupled to the second receive feeding point via the first adder so that the first antenna is coupled to the first transmit feeding point and the second receive feeding point respectively via the first circulator;
a second circulator having a first port, a second port and a third port, the first port being coupled to the first transmit feeding point, the second port being coupled to the second antenna, and the third port being coupled to the second receive feeding point via the first adder so that the second antenna is coupled to the first transmit feeding point and the second receive feeding point respectively via the second circulator;
a third circulator having a first port, a second port and a third port, the first port being coupled to the second transmit feeding point, the second port being coupled to the third antenna, and the third port being coupled to the first receive feeding point via the second adder so that the third antenna is coupled to the second transmit feeding point and the first receive feeding point respectively via the third circulator; and
a fourth circulator having a first port, a second port and a third port, the first port being coupled to the second transmit feeding point via the second inverter, the second port being coupled to the fourth antenna, and the third port being coupled to the first receive feeding point via the second adder so that the fourth antenna is coupled to the second transmit feeding point and the first receive feeding point respectively via the fourth circulator;
wherein the first antenna and the fourth antenna have a distance d_{1,4} therebetween, the second antenna and the fourth antenna have a distance d_{2,4} therebetween, a distance difference between d_{1,4} and d_{2,4} is substantially 0, a distance difference between d_{1,3} and d_{1,4} is substantially 0, and a distance difference between d_{2,3} and d_{2,4} is substantially 0.

7. A wireless device, comprising:
an FDR transceiver, comprising a first transmit feeding point and a first receive feeding point, and being configured to transmit a first transmitted signal from the first transmit feeding point and receive a first received signal from the first receive feeding point;
an antenna module, comprising:
a first inverter;
a first adder;
a first antenna coupled to the first transmit feeding point;
a second antenna coupled to the first receive feeding point via the first inverter and the first adder; and
a third antenna coupled to the first receive feeding point via the first adder;
wherein the first antenna and the second antenna have a distance d_{1,2} therebetween, the first antenna and the third antenna have a distance d_{1,3} therebetween, and a distance difference between d_{1,2} and d_{1,3} is substantially 0.

8. The wireless device of claim 7, wherein the antenna module further comprises a controller, a first delayer and a second delayer, the controller is coupled to the first delayer, the second delayer and the first receive feeding point and is configured to adjust a delay value of the first delayer and a delay value of the second delayer according to the first received signal, the second antenna is coupled to the first receive feeding point via the first inverter, the first delayer and the first adder, and the third antenna is coupled to the first receive feeding point via the second delayer and the first adder.

9. The wireless device of claim 7, wherein:
the FDR transceiver further comprises a second transmit feeding point and is further configured to transmit a second transmitted signal from the second transmit feeding point;
the antenna module further comprises a fourth antenna coupled to the second transmit feeding point;
wherein the fourth antenna and the second antenna have a distance d_{4,2} therebetween, the fourth antenna and the third antenna have a distance d_{4,3} therebetween, and a distance difference between d_{4,2} and d_{4,3} is substantially 0.

10. The wireless device of claim 9, wherein:
the FDR transceiver further comprises a second receive feeding point, and is further configured to receive a second received signal from the second receive feeding point;
the antenna module further comprises:
a second inverter;
a second adder;
a fifth antenna coupled to the second receive feeding point via the second inverter and the second adder;
a sixth antenna coupled to the second receive feeding point via the second adder;
wherein the first antenna and the fifth antenna have a distance d_{1,5} therebetween, the first antenna and the sixth antenna have a distance d_{1,6} therebetween, the fourth antenna and the fifth antenna have a distance d_{4,5} therebetween, the fourth antenna and the sixth antenna have a distance d_{4,6} therebetween, a distance difference between d_{1,5} and d_{1,6} is substantially 0, and a distance difference between d_{4,5} and d_{4,6} is substantially 0.

11. The wireless device of claim 10, wherein the antenna module further comprises a controller, a first delayer, a second delayer, a third delayer and a fourth delayer, the controller is coupled to the first delayer, the second delayer, the third delayer, the fourth delayer, the first receive feeding point and the second receive feeding point and is configured to adjust a delay value of the first delayer, a delay value of the second delayer, a delay value of the third delayer and a delay value of the fourth delayer according to the first received signal and the second received signal, the second antenna is coupled to the first receive feeding point via the first inverter, the first delayer and the first adder, the third antenna is coupled to the first receive feeding point via the second delayer and the first adder, and the fifth antenna is coupled to the second receive feeding point via the second inverter, the third delayer and the second adder, and the sixth antenna is coupled to the second receive feeding point via the fourth delayer and the second adder.

12. The wireless device of claim 7, wherein:
the FDR transceiver further comprises a second transmit feeding point and a second receive feeding point and is configured to transmit a second transmitted signal from the second transmit feeding point and receive a second received signal from the second receive feeding point;
the antenna module further comprises:
a first adder;
a second adder;
a second inverter;
a fourth antenna; and
a first circulator having a first port, a second port and a third port, the first port being coupled to the first transmit feeding point, the second port being coupled to the first antenna, and the third port being coupled to the second receive feeding point via the second inverter and the second adder so that the first antenna is coupled to the first transmit feeding point and the second receive feeding point respectively via the first circulator;
a second circulator having a first port, a second port and a third port, the first port being coupled to the second transmit feeding point, the second port being coupled to the second antenna, and the third port being coupled to the first receive feeding point via the first inverter and the first adder so that the second antenna is coupled to the second transmit feeding point and the first receive feeding point respectively via the second circulator;
a third circulator having a first port, a second port and a third port, the first port being coupled to the second transmit feeding point, the second port being coupled to the third antenna, and the third port being coupled to the first receive feeding point via the first adder so that the third antenna is coupled to the second transmit feeding point and the first receive feeding point respectively via the third circulator; and
a fourth circulator having a first port, a second port and a third port, the first port being coupled to the first transmit feeding point, the second port being coupled to the fourth antenna, and the third port being coupled to the second receive feeding point via the second adder so that the fourth antenna is coupled to the first transmit feeding point and the second receive feeding point respectively via the fourth circulator;
wherein the first antenna and the second antenna have a distance d_{1,2} therebetween, the second antenna and the fourth antenna have a distance d_{2,4} therebetween, a distance difference between d_{1,2} and d_{2,4} is substantially 0, a distance difference between d_{1,3} and d_{3,4} is substantially 0, and a distance difference between d_{2,3} and d_{3,4} is substantially 0.

13. A wireless device, comprising:
an FDR transceiver comprising a first transmit feeding point and a first receive feeding point, and being configured to transmit a first transmitted signal from the first transmit feeding point and receive a first received signal from the first receive feeding point;
an antenna module, comprising:
a first antenna coupled to the first transmit feeding point;
a second antenna coupled to the first transmit feeding point; and
a third antenna coupled to the first receive feeding point;
wherein the first antenna and the third antenna have a distance d_{1,3} therebetween, the second antenna and the third antenna have a distance d_{2,3} therebetween, and a distance difference between d_{1,3} and d_{2,3} is substantially λ/2, where λ is a wavelength corresponding to an operation frequency of the FDR transceiver.

14. The wireless device of claim 13, wherein the antenna module further comprises a controller, a first delayer and a second delayer, the controller is coupled to the first delayer, the second delayer and the first receive feeding point and is configured to adjust a delay value of the first delayer and a delay value of the second delayer according to the first received signal, the first antenna is coupled to the first transmit feeding point via the first delayer, and the second antenna is coupled to the first transmit feeding point via the second delayer.

15. The wireless device of claim 13, wherein:
the FDR transceiver further comprises a second transmit feeding point and is further configured to transmit a second transmitted signal from the second transmit feeding point;
the antenna module further comprises:
a fourth antenna coupled to the second transmit feeding point; and
a fifth antenna coupled to the second transmit feeding point;
wherein the fourth antenna and the third antenna have a distance d_{4,3} therebetween, the fifth antenna and the third antenna have a distance d_{5,3} therebetween, and a distance difference between d_{4,3} and d_{5,3} is substantially λ/2.

16. The wireless device of claim 15, wherein:
the FDR transceiver further comprises a second receive feeding point and is further configured to receive a second received signal from the second receive feeding point;
the antenna module further comprises a sixth antenna coupled to the second receive feeding point;
wherein the first antenna and the sixth antenna have a distance d_{1,6} therebetween, the second antenna and the sixth antenna have a distance d_{2,6} therebetween, the fourth antenna and the sixth antenna have a distance d_{4,6} therebetween, the fifth antenna and the sixth antenna have a distance d_{5,6} therebetween, a distance difference between d_{1,6} and d_{2,6} is substantially λ/2, and a distance difference between d_{4,6} and d_{5,6} is substantially λ/2.

17. The wireless device of claim 16, wherein the antenna module further comprises a controller, a first delayer, a second delayer, a third delayer and a fourth delayer, the controller is coupled to the first delayer, the second delayer, the third delayer, the fourth delayer, the first receive feeding point and the second receive feeding point and is configured to adjust a delay value of the first delayer, a delay value of the second delayer, a delay value of the third delayer and a delay value of the fourth delayer according to the first received signal and the second received signal, the first antenna is coupled to the first transmit feeding point via the first delayer, the second antenna is coupled to the first transmit feeding point via the second delayer, the fourth antenna is coupled to the second transmit feeding point via the third delayer, and the fifth antenna is coupled to the second transmit feeding point via the fourth delayer.

18. A wireless device, comprising:
an FDR transceiver comprising a first transmit feeding point and a first receive feeding point, and being configured to transmit a first transmitted signal from the first transmit feeding point and receive a first received signal from the first receive feeding point;
an antenna module, comprising:
a first adder;
a first antenna coupled to the first transmit feeding point;
a second antenna coupled to the first receive feeding point via the first adder; and
a third antenna coupled to the first receive feeding point via the first adder;
wherein the first antenna and the second antenna have a distance d_{1,2} therebetween, the first antenna and the third antenna have a distance d_{1,3} therebetween, and a distance difference between d_{1,2} and d_{1,3} is substantially λ/2, where λ is a wavelength corresponding to an operation frequency of the FDR transceiver.

19. The wireless device of claim 18, wherein the antenna module further comprises a controller, a first delayer and a second delayer, the controller is coupled to the first delayer, the second delayer and the first receive feeding point and is configured to adjust a delay value of the first delayer and a delay value of the second delayer according to the first received signal, the second antenna is coupled to the first receive feeding point via the first delayer and the first adder, and the third antenna is coupled to the first receive feeding point via the second delayer and the first adder.

20. The wireless device of claim 18, wherein:
the FDR transceiver further comprises a second transmit feeding point and is further configured to transmit a second transmitted signal from the second transmit feeding point;
the antenna module further comprises a fourth antenna coupled to the second transmit feeding point;
wherein the fourth antenna and the second antenna have a distance d_{4,2} therebetween, the fourth antenna and the third antenna have a distance d_{4,3} therebetween, and a distance difference between d_{4,2} and d_{4,3} is substantially λ/2.

21. The wireless device of claim 20, wherein:
the FDR transceiver further comprises a second receive feeding point and is further configured to receive a second received signal from the second receive feeding point;
the antenna module further comprises:
a second adder;
a fifth antenna coupled to the second receive feeding point via the second adder;
a sixth antenna coupled to the second receive feeding point via the second adder;
wherein the first antenna and the fifth antenna have a distance d_{1,5} therebetween, the first antenna and the sixth antenna have a distance d_{1,6} therebetween, the fourth antenna and the fifth antenna have a distance d_{4,5} therebetween, the fourth antenna and the sixth antenna have a distance d_{4,6} therebetween, a distance difference between d_{1,5} and d_{1,6} is substantially λ/2, and a distance difference between d_{4,5} and d_{4,6} is substantially λ/2.

22. The wireless device of claim 21, wherein the antenna module further comprises a controller, a first delayer, a second delayer, a third delayer and a fourth delayer, the controller is coupled to the first delayer, the second delayer, the third delayer, the fourth delayer, the first receive feeding point and the second receive feeding point and is configured to adjust a delay value of the first delayer, a delay value of the second delayer, a delay value of the third delayer and a delay value of the fourth delayer according to the first received signal and the second received signal, the second antenna is coupled to the first receive feeding point via the first delayer and the first adder, the third antenna is coupled to the first receive feeding point via the second delayer and the first adder, the fifth antenna is coupled to the second receive feeding point via the third delayer and the second adder, and the sixth antenna is coupled to the second receive feeding point via the fourth delayer and the second adder.
